(19) United States
(12) Patent Application Publication
(10) Pub. No.: US 2005/0196070 A1
(43) Pub. Date: Sep. 8, 2005

(54) Image combine apparatus and image combining method

(75) Inventors: Hiroyuki Takakura, Kawasaki (JP); Jun Moroo, Kawasaki (JP); Tsugio Noda, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/091,822

(22) Filed: Mar. 29, 2005

Related U.S. Application Data
(63) Continuation of application No. PCT/JP03/02350, filed on Feb. 28, 2003.

(51) Int. Cl. G06K 9/00; G06K 9/32

(52) U.S. Cl. 382/284; 382/294

(57) ABSTRACT

An input image distortion detection unit 11 detects a distortion of each of a plurality of input images (two herein) and corrects the distortion of each image. An overlapping position detection unit 12 detects the overlapping position of the two input images being combined using the images after subjecting to correction for distortion. A mutual distortion and expansion/contraction detection unit 13 detects a mutual distortion or expansion/contraction of the two images being combined in the overlapping position. Based on these detection results, the mutual distortion of the two input images is corrected or the expansion/contraction is interpolated. Finally image superimpose unit 15 combines the two images.

### CROSS REFERENCE TO RELATED APPLICATION

This application is a continuation of international PCT application No. PCT/JP03/02350 filed on Feb. 28, 2003.

### BACKGROUND OF THE INVENTION

1. Field of the Invention

The present invention relates to an image combine apparatus, image combining method program, storage media, et cetera, acquiring the whole image of an original scanned object by combining a plurality of images obtained by scanning partially the object thereof manually in a plurality of times by using a manual operation type scanner such as a handheld scanner, et cetera.

2. Description of the Related Art

In recent years, easily transportable, manual operation type hand-held scanners have been developed for commercial use in addition to the stationary flat head scanners. The handheld scanners are generally built in the compact bodies, limiting the width of a single scan narrow. To take in a larger image than the scanning width, it is necessary to pick up the image partially in a plurality of times and combine them together. It can also be considered that the user may scan an image partially in a plurality of times even if the image width is not exceeding the scanner width. Such a case is conceivable since it is the user's discretion as to how to operate a scanner after all.

There have conventionally been some techniques available for combining a plurality of images optically picked up of the object of scanning (e.g., newspaper, book, photograph, drawing) partially in a plurality of times by using a hand held scanner, et cetera. The methods respectively presented by patent documents 1 and 2, listed below, exemplify such image combing techniques.

The method presented by the patent document 1 extracts a character area for each of a plurality of document images obtained by picking up a document as the object of scanning (e.g., newspaper, book) partially in a plurality of times, performs a character recognition of the character image within the extracted character area, detects an overlapping of a plurality of the document images based on a result of the character recognition of each document image and combines a plurality of document images at the detected overlapping position. This makes it possible to combine a plurality of documents automatically without a specific user operation for combining a plurality of document images picked up partially or without marking the document, et cetera, for indicating a combination. The patent document 1 also proposes an enabling method, among others, which divides a document image, containing a table, graphics, et cetera, into a plurality of areas, extracts a line image excluding a graphics by extracting a line image off each area and detects the overlapping position of the document image accurately by comparing the character area of those line images.

The method presented by the patent document 2 relates to a technique for combining a plurality of images picked up by partially scanning an object a plurality of times, especially where the object of scanning is something (e.g., photograph, figure) other than the above noted document image, and in particular to a method for speeding up the processing and reducing a memory capacity required during the processing. The technique, for instance, converts a picked up plurality of input image data into an image data of a reduced size, detects and stores a combination positional relationship and an overlapping area of the plurality of input image by using the converted image data, and combines the plurality of input images based on the stored combination positional relationship and overlapping area. The user, when picking up an image partially in a plurality of times by discretionarily operating a handheld scanner, et cetera, for instance, has no idea about the combination positional relationship of the plurality of images (e.g., presence or absence of mirror image reversal; rotation angle) (and in addition, positional relationship, i.e., up, down, left and right). In an image combine apparatus according to the above noted patent document 2, a coarse detection of an overlapping position is accomplished by using an image data of a reduced size such as a reduced image size of the input image. Also converts an input image of a color image into a gray scale image to detect a correct overlapping position and a combination plane at the above noted coarse overlapping position by using the gray scale image. And a combination processing by using an input image of large size data is performed by using the above noted series of outputs, thereby speeding up the processing while saving a memory size required for the processing.

The patent document 2 further proposes a method to compensate for an inclination if there is one in at least a plurality of input images picked up by scanning an object thereof partially in a plurality of times.
[Patent document 1] Japanese patent laid-open application publication No. 2000-278514
[Patent document 2] Japanese patent laid-open application publication No. 2002-305647

Meanwhile, neither of the techniques proposed by the above noted patent documents 1 and 2 has considered an automatic correction of a distortion, expansion or contraction in a scanned image caused by an operation of a handheld scanner by the user.

Let it be explained about distortion, expansion or contraction caused by a handheld scanner at this point in time.

FIG. 44 is a plain view of the original document contact surface of a common handheld image scanner for describing a configuration thereof. As shown by FIG. 44, a handheld image scanner 400 (simply “image scanner 400” hereinafter) comprises basically a one-dimensional line sensor 401 for picking up an image, a plurality of rollers 402 (e.g., four rollers are shown in FIG. 44) rotating in contact with the original document according to the scanning operation by the user (i.e., operator) and a one-dimensional rotary encoder (not shown in FIG. 44) for detecting the number of rotation of the rollers 402 in order to detect the moving distance of the image scanner 400 corresponding to the scanning operation. Note that the plurality of rollers 402 are mounted onto the same common rotating shaft so as to rotate together, and that the primary scanning width of the line sensor 401 is a fixed length W.

For picking up an image by using the above noted image scanner 400, the user holds the image scanner 400 by hand and moves it in a specified direction (i.e., the feed direction) along the image on a sampling object, during which time the rollers 402 rotate along with the movement of the image scanner 400 and the encoder detects the number of rotation. Accordingly, an image data for one line in the cross feed direction (“line data” hereinafter) is gained by the line sensor 401 at timing in synchronous with the detected number of rotations of the rollers 402, and the line data is transmitted from the image scanner 400 to an information processing apparatus line by line. The image on the sampling object is taken in by the information processing apparatus as the image data made up of a plurality of line data consisting image data along the cross feed direction being arrayed in the feed direction.

Incidentally, the direction of scanning operation (i.e., feed direction) of the image scanner 400 by the user should desirably be either in parallel with, or vertical to, the direction of character string in the document if the sample object image is a document image.

A mechanism that would regulate the moving direction of the image scanner 400 in one direction relative to the image of a sample object, however, is not actually equipped. While there is a slight restraining force provided by the above noted rollers 402 so as to let the image scanner 400 travel in the rotational direction of the rollers 402, the restraining force is so small as to regulate the traveling direction thereof.

Therefore, the freedom of operation of the handheld image scanner 400 by the user is high so that the operational direction scanning (i.e., moving direction) of the image scanner 400 fluctuates independent of the user awareness, resulting in distorting the picked up image in many occasions.

For instance, let a case be considered where the user places an image original right in front of her to pick up the image by moving the image scanner 400 toward her.

In this case, if aright-handed user holds the image scanner 400 by her right hand, her hand will move in a way that her right elbow moves to her right as the image scanner 400 approach toward her. With such a movement of the arm, the operational direction of the image scanner 400 tends to be sidetracked slightly toward the right unconsciously as shown by FIG. 45A. For a left handed user, the operational direction tends to be sidetracked toward the left. In these cases, the image picked up by the image scanner 400 will show an out of displacement (misalignment) in the direction of the line sensor (i.e., cross feed direction) depending on the operational direction (i.e., feed direction), that is, a distortion.

In addition, with the above described arm movement, there is a possibility of one end of the image scanner 400 (i.e., the left side in FIG. 45B) slipping in addition to side tracking itself toward right, causing the scanning area of the image scanner to become a fan shape in some cases as shown by FIG. 45B. The image data picked up by the image scanner 400 is distorted in the direction of not only the line sensor (i.e., cross feed direction) but also the operational direction (i.e., feed direction).

Here, a conventional technique has been proposed to mount an optical two-dimensional sensor in an image scanner, detect the movement thereof on the image original two-dimensionally by the two-dimensional sensor, and correct the distortion of the image data picked up by the handheld image scanner according to the detection result. In this configuration, the optical two-dimensional sensor detects how the image scanner body has moved in two dimensions after starting to scan by tracking slight irregularities of the image forming surface such as paper sheet.

The problem, however, is a manufacturing cost of the image scanner if comprising a two-dimensional sensor, since the above noted two-dimensional sensor is expensive, even though the distortion of the image data can be corrected thereby. Therefore, a method has been desired for estimating and correcting a distortion of image data by using the picked up image by a line sensor without adding a two-dimensional sensor, et cetera.

Particularly, it is necessary to correct a distortion of each image for combining a plurality of images picked up by scanning a scanning object partially in a plurality of times. Otherwise a degradation in a detection accuracy of overlapping position will result.

Now, a description will be given about a case for combining a plurality of images picked up partially in a plurality of times.

As exemplified by FIG. 46A, if a scanning object (e.g., photograph, newspaper) is wider than the width of the fact scan direction W of the line sensor 401 equipped in the image scanner 400, the scanning operation is done partially in a plurality of times. In the example shown by FIG. 46, two scans are performed as shown by (1) and (2). As a result, two input images are gained (i.e., images A and B) as shown by FIG. 46B. Then, parts picked up in duplication in the two images A and B (shown by a triangle, square and circle) are detected, that is, overlapping parts, to combine the two images at the overlapping positions as shown by FIG. 47.

Here, when the user performs at least either one of (1) or (2) scan operations, if she operates an operation for instance as shown by FIG. 48A, that is, the operation as described in FIG. 45A (and there is of course a possibility of operation as shown by FIG. 45B), and as a result, gaining a distorted image as shown by FIG. 48B (i.e., image B′), it is not possible to combine the images A and B′ since the image B′ is so distorted that a correct overlapping position is unable to be detected. Furthermore, if a distortion of image is larger, then finding an overlapping position may not be possible.

Or, even if overlapping parts are detected, the overlapping parts may not match, causing a problem of degraded image quality in the superimposed part due to a displacement of pixels. This makes a degradation of image quality in the superimposed part unavoidable because the overlapping parts of the two images do not match completely (that is, there will be a distortion of the images), unless the two images are corrected to the original images, even if the distortion of the image B′ is corrected so as to be able to detect an overlapping part.

Therefore, it is necessary to not only correct the above described distortion but also to detect and correct the mutual distortion of images. Detection, et cetera of such distortion of course is required to be enabled without a special configuration such as a two-dimensional sensor.

Furthermore, the problem of “expansion and/or contraction” has not conventionally been dealt with.

As well known, the “expansion and/or contraction” is caused by scanning speed being too fast for instance, losing a part of the line data and hence the whole image looking like it is contracted.

### SUMMARY OF THE INVENTION

It is an object of the present invention to provide an image combine apparatus, image combining method, program, et cetera, capable of generating a high quality combination image by detecting the overlapping position of the image through correcting a distortion of the image automatically and further correcting or interpolating a mutual image distortion or expansion/contraction through a detection thereof, without using a specific configuration such as such as a two-dimensional sensor.

An image combine apparatus according to the present invention comprises an image distortion detection/correction unit for correcting a distortion of each image based on a result of detecting the distortion of each of a plurality of images being picked up by scanning an object thereof partially in the plurality of times by a manual operation type scanner, an overlapping position detection unit for detecting a mutual overlapping area of images by using each of the images corrected for distortion, a mutual image distortion and expansion/contraction detection unit for detecting a mutual distortion of the respective images or an expansion/contraction of image within the detected overlapping area, an image correction unit for correcting the plurality of images based on the detected mutual distortion of images or the expansion/contraction and an image superimpose unit for superimpose the plurality of images after the correction.

Since a freedom of scanning operation by the user is high when using the manual operation type scanner such as a handheld scanner, the image may be distorted as a result of the operating direction of the scanner being sidetracked for instance so as to draw a curve for instance. Or, if a scanning operation is too fast, the so called expansion/contraction may occur as a result of a part of the line data failing to be picked up.

In the above noted image combine apparatus, first, the image distortion detection/correction unit detects and corrects a respective image distortion for each image. This eliminates a possibility of mutual overlapping positions of the plurality of images being unable to be detected. Since there is a possibility of incomplete matching if a plurality of corrected images, even after a correction for distortion, are subjected to combination thereof, the mutual image distortion and expansion/contraction detection unit detects a mutual distortion of the images, the image correction unit corrects the images and the image superimpose unit combines the plurality of images. This makes it possible to generate a combined image of high image quality if there is a distortion in the image beforehand. While the image distortion detection/correction unit cannot detect or correct an image expansion/contraction if there is any, the mutual image distortion and expansion/contraction detection unit can detect such expansion/contraction by detecting a mutual displacement of the image to correct it if there is any, hence generating a combined image of high image quality.

Meanwhile, in the above described image combine apparatus, a configuration may be such that the image is made up of a plurality of line data along the cross feed direction being arrayed in the feed direction, the image distortion detection/correction unit extracts the line data sequentially distanced by a predetermined interval in the feed direction, estimates displacement amounts in the cross feed direction based on a mutual correlation between the extracted line data and corrects the image so as to eliminate displacement therein based on the estimated displacement amounts, for instance.

A detection of image distortion becomes possible by taking advantage of the fact that the line data not distanced so far from each other do not change as much, using a mutual correlation between the line data distanced at an appropriate interval (e.g., approximately 5 to 20 lines) and estimating a displacement amount between the respective line data.

Meanwhile, in the above described image combine apparatus, a configuration may be such that an image used for processing performed by the image distortion detection/correction unit, overlapping position detection unit, and mutual image distortion and expansion/contraction detection unit is a converted image converted from the plurality of picked up images into an image with its data size reduced, the image distortion detection/correction unit, overlap position detection unit, and mutual image distortion and expansion/contraction detection unit temporarily store the detection result acquired by using the converted image, and the image correction unit and image superimpose unit corrects and superimposes, respectively, the plurality of picked up images by using the temporarily stored detection result, for instance.

If an input image obtained by picking up by a handheld scanner is a color and/or high resolution image for instance, a series of processing by the above described image combine apparatus require a substantial amount of processing time and memory size. Therefore, first creates a converted image converted from the input image into an image with its data reduced. The converted image is such as a gray scale, binarized, reduction images, et cetera, which is used for the processing by the image distortion detection/correction unit, overlap position detection unit, and mutual image distortion and expansion/contraction detection unit, followed by a correction and combination of the input image based on these processing results (i.e., detection results) in the end, thereby enabling the processing time and memory size to be reduced.

Note that the present invention can also be configured as an image combining method as a processing method performed by the above described image combine apparatus.

The previously described problems can also be solved by making a computer read, and execute, a program for performing the same control as the functions of the above described respective functional units according to the present invention out of a computer readable storage medium storing the program. That is, the present invention can also be configured as a program per se for making a computer accomplish the functions of the above described image combine apparatus, or as a storage media per se storing the program.

### BRIEF DESCRIPTION OF THE DRAWINGS

The present invention will be more apparent from the following detailed description when the accompanying drawings are referenced to.

FIG. 1 is a functional block diagram of an image combine apparatus;

FIG. 2 shows a flow chart for describing a processing procedure of a first embodiment;

FIG. 3 shows a detailed flow chart of “detection of mutual distortion, expansion and contraction” in the step S20 of FIG. 2 or the step S41 of FIG. 4;

FIG. 4 shows a flow chart for describing a processing procedure of a second embodiment;

FIG. 5 is a block chart showing a configuration of image processing apparatus according to the previous invention application;

FIG. 6 shows a flow chart for describing an operation of an image processing apparatus according to the previous invention application;

FIG. 7 shows a detailed flow chart of displacement amount estimation processing;

FIG. 8A through 8C shows drawings for describing displacement amount estimation processing by using examples;

FIG. 9 exemplifies an extraction area of line data;

FIG. 10A shows a displacement estimation result; FIG. 10B shows a smoothing processing result;

FIG. 11A exemplifies an overlapping area divided into a plurality of rectangular areas; FIG. 11B shows how a rectangular area containing many density components with large color differences is extracted;

FIG. 12A and FIG. 12B show a rectangular area used for detecting an accurate overlap position;

FIG. 13 exemplifies detection of a mutual distortion of two images (part 1);

FIG. 14 exemplifies detection of a mutual distortion of two images (part 2);

FIG. 15 exemplifies detection of an expansion/contraction;

FIG. 16 exemplifies detection of a mutual distortion of images relating to a document image;

FIG. 17A through 17C describes a correction method for an expanded/contracted image;

FIG. 18A exemplifies a linear interpolation and FIG. 18B exemplifies a spline interpolation;

FIG. 19 shows an image of interpolation;

FIG. 20 shows how expanded/contracted images are combined after an interpolation;

FIG. 21 exemplifies a combination method for a document image (part 1);

FIG. 22 exemplifies a combination method for a document image (part 2);

FIG. 23 is a block diagram showing a configuration of image processing apparatus according to the other method (part 1) presented by the previous patent application;

FIG. 24 is a drawing (part 1) for describing an image processing method according to the other method (part 1) proposed by the previous patent application;

FIG. 25 is a drawing (part 2) for describing an image processing method according to the other method (part 1) proposed by the previous patent application;

FIG. 26 is a drawing (part 3) for describing an image processing method according to the other method (part 1) proposed by the previous patent application;

FIG. 27 is a drawing (part 4) for describing an image processing method according to the other method (part 1) proposed by the previous patent application;

FIG. 28 is a drawing (part 5) for describing an image processing method according to the other method (part 1) proposed by the previous patent application;

FIG. 29 is a drawing (part 6) for describing an image processing method according to the other method (part 1) proposed by the previous patent application;

FIG. 30 is a drawing (part 7) for describing an image processing method according to the other method (part 1) proposed by the previous patent application;

FIGS. 31A and 31B describes a detection method for image inclination;

FIG. 32 is a block diagram showing a configuration of image processing apparatus according to the other method (part 2) presented by the previous patent application;

FIG. 33 is a flow chart for describing an image processing method performed by an image processing apparatus;

FIG. 34 describes a method for estimating an image inclination (border inclination) on the top and bottom sides of a block;

FIG. 35 describes an example of a border whose inclination is wrongly estimated (part 1);

FIG. 36 describes an example of a border whose inclination is wrongly estimated (part 2);

FIG. 37 describes an example selection of a control point for a Bezier curve;

FIG. 38 describes a connection state between blocks after a reconstruction;

FIG. 39 describes an image processing method according to the present example (part 1);

FIG. 40 describes an image processing method according to the present example (part 2);

FIG. 41 describes an image processing method according to the present example (part 3);

FIG. 42 exemplifies a hardware configuration of a computer accomplishing an image combine apparatus and image combining method according to the present invention;

FIG. 43 exemplifies a storage media and a download;

FIG. 44 exemplifies an external configuration drawing of a handheld image scanner;

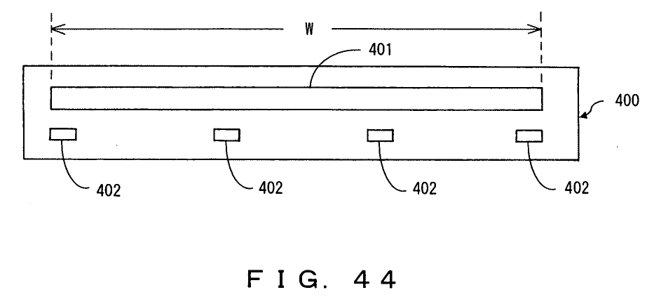

FIGS. 45A and 45B exemplifies a user operation causing an image distortion;

FIG. 46A exemplifies an operation of picking up a scanning object partially in a plurality of times; FIG. 46B exemplifies a plurality of input images obtained by the result of the operation;

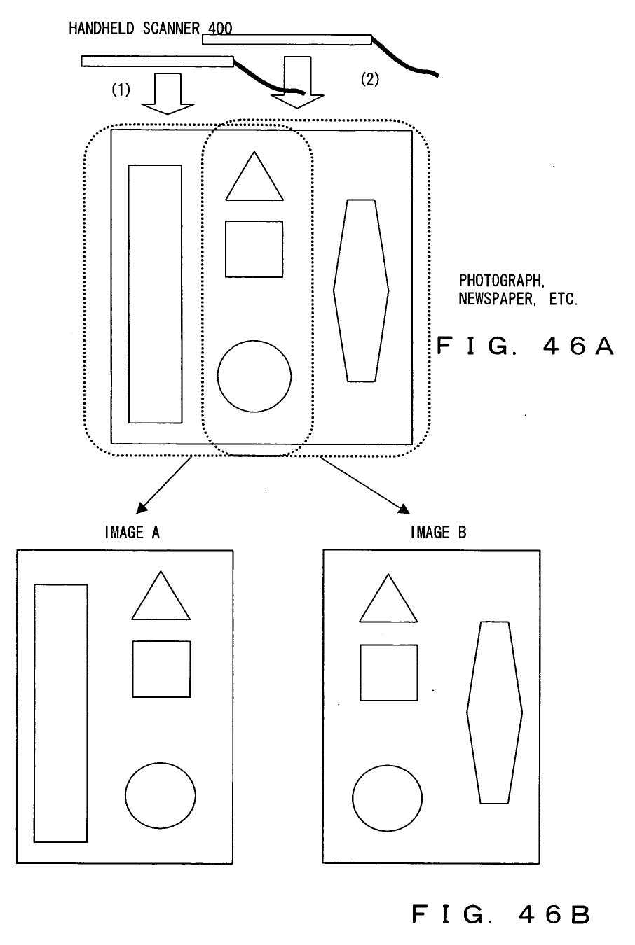

FIG. 47 shows a combine of a plurality of images picked up partially in the plurality of times;

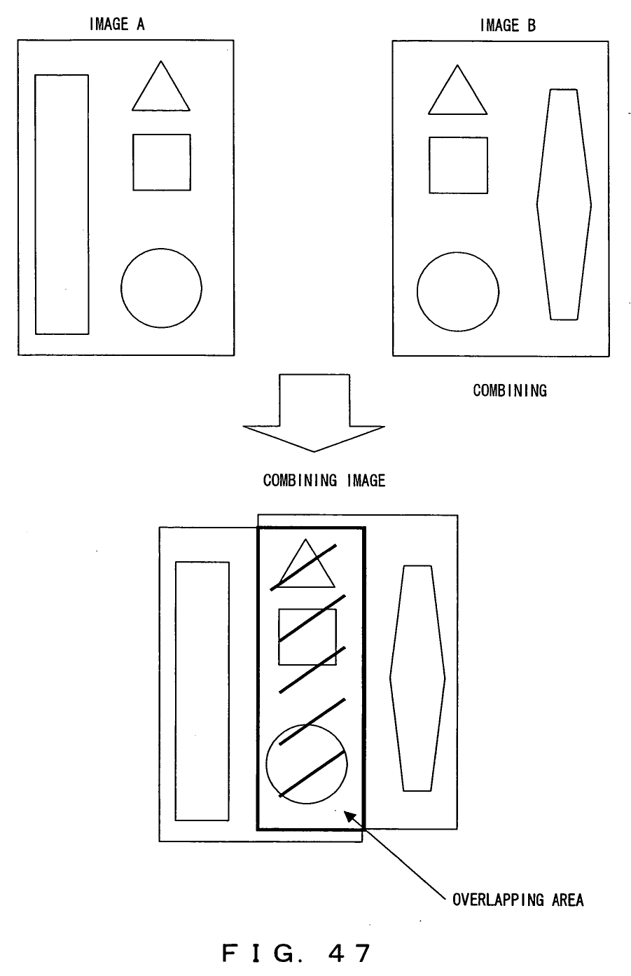

FIG. 48A exemplifies an operation causing an image distortion; FIG. 48B exemplifies an input image obtained by the operation;

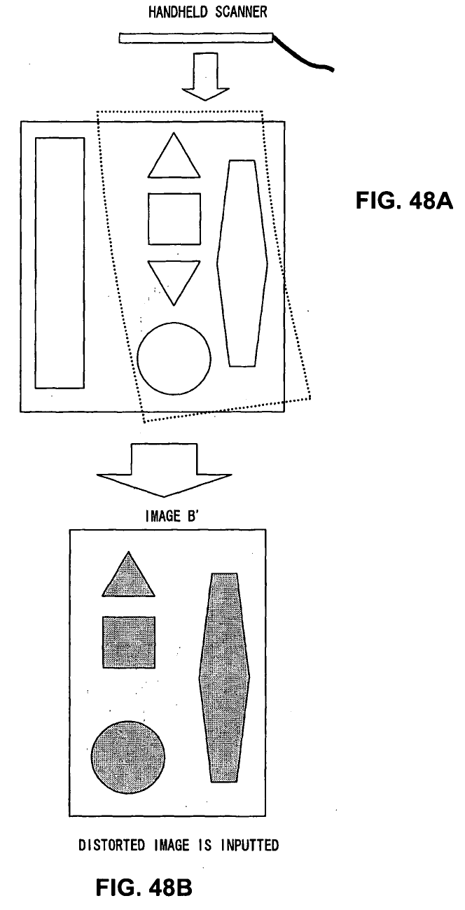

FIG. 49 shows how an image combine is done by using distorted images.

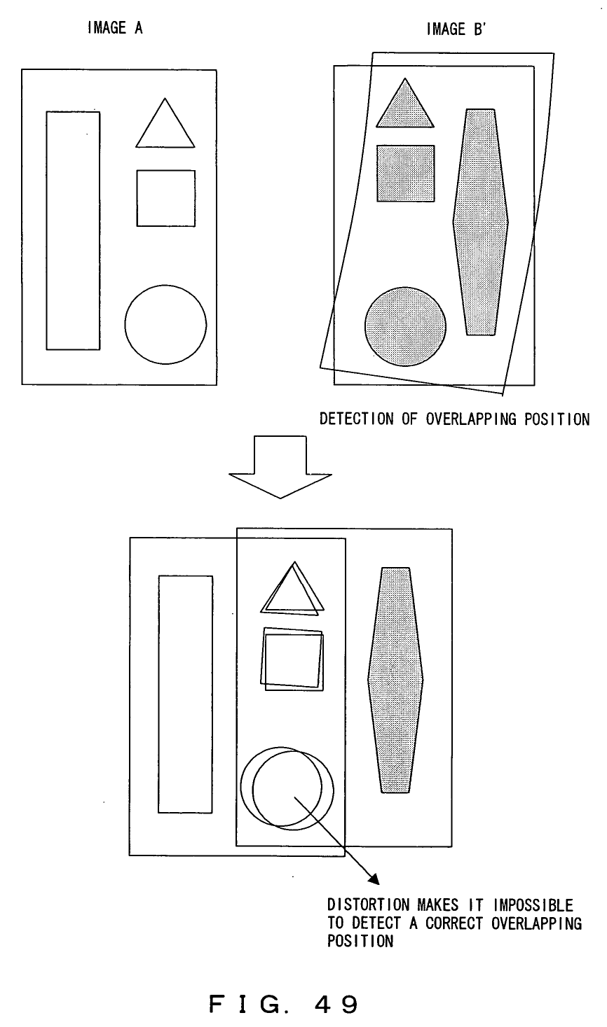

### DESCRIPTION OF THE PREFERRED EMBODIMENT

An embodiment according to the present invention will be described while referring to the accompanying drawings in the following.

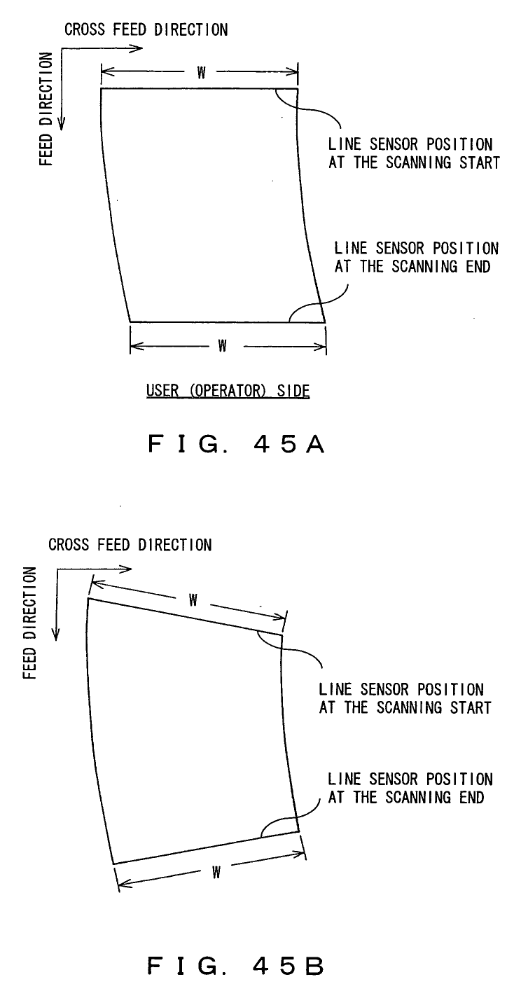

Note that the description in the following exemplifies a handheld type scanner, the present invention, however, is not limited to the following example but is applied to all types of scanners which have a possibility of causing an image distortion as shown by the above noted FIGS. 45A and 45B, or an image expansion/contraction (not shown). Such scanners are commonlycalled a “manual operation type scanner” herein.

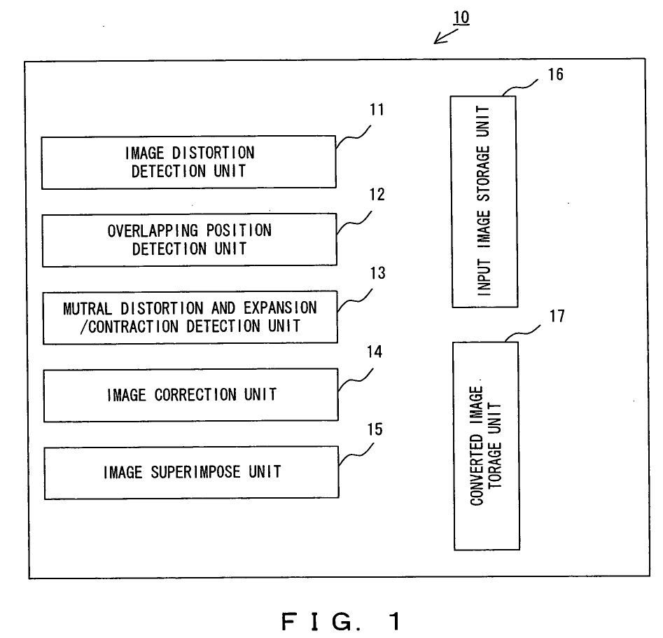

FIG. 1 is a functional block diagram of an image combine apparatus according to the present embodiment.

The image combine apparatus 10 shown by FIG. 1 comprises an image distortion detection unit 11, an overlapping position detection unit 12, a mutual distortion and expansion/contraction detection unit 13, an image correction unit 14, an image superimpose unit 15 as functional units; and further comprises an input image storage unit 16 and a converted image storage unit 17.

Note that the image combine apparatus 10 is actually accomplished by an image processing apparatus equipped with a certain information processing function such as a personal computer for instance. That is, a certain storage apparatus such as RAM, ROM, hard disk, et cetera, equipped in an information processing apparatus performs as the functions of the input image storage unit 16 and the converted image storage unit 17. And a CPU comprised by the information processing apparatus executing an image combination program for accomplishing the function of each functional unit shown by FIG. 1 accomplishes the respective functional units, that is, image distortion detection unit 11, overlapping position detection unit 12, mutual distortion and expansion/contraction detection unit 13, image correction unit 14 and image superimpose unit 15. The above noted image combination program is stored in hard disk, or stored in a portable storage media such as CD-ROM, FD (flexible disk), et cetera, to be read out by a memory such as RAM and executed by the CPU. The above noted image combination program may alternatively be stored by another external information processing apparatus to be downloaded by way of a network such as the Internet and executed by the CPU.

The input image storage unit 16 is an image buffer for retaining a plurality of input image data being picked up by scanning a certain object thereof such as newspaper, magazine, design drawing, photograph, et cetera, partially in a plurality of times by using a handheld image scanner (may be simply called “image scanner” thereafter). The input image data is made up of arraying many rows of line data along the cross feed direction in the direction of slow scan.

The converted image storage unit 17 temporarily stores a converted image converted from input image data stored in the input image storage unit 16 into the later described gray scale, binarized, reduced images, et cetera, for instance.

Note that the following description exemplifies data obtained by picking up a scanning object partially in two times and the input image storage unit 16 storing the resultant two pieces of input image data for the sake of simplicity.

The image distortion detection unit 11 detects an image distortion individually for each of the two pieces of input image data being stored in the above noted input image storage unit 16, and also corrects the respective distortion for each image based on the distortion detection result. Detection method for image distortion may adopt the method described already by the applicant of the present invention in the patent application, i.e., Japanese patent application No. 13-320620 (“the previous application” hereinafter), applied by the inventing entity of the present invention, for instance, or any other relevant methods. The distortion detection/correction method noted in the previous application will be described in detail in a later paragraph herein. Meanwhile, it can be summarized as extracting a plurality of data areas from a surrounding area of which a distortion is to be compared and detected, followed by figuring out a mutual correlation while moving along the direction of x-axis. A distortion of image is detected by judging the positional relationship where the value derived from the mutual relationship becomes the maximum as the mutual displacement, followed by correcting the image based on the detection result.

Meanwhile, a distortion detection/correction processing by the image distortion detection unit 11 may adopt the method presented by the patent document 2 (Japanese patent laid-open application publication No. 2002-305647) to convert an input image, if it is one having RGB color components into a gray scale image having a single color component or a binarized image, store the converted image data in the converted image storage unit 17 and detect a distortion of the image by using the converted image data. Or the conversion result may be a reduced size image. A processing for an input image having a large size data first by detecting a distortion of the image by using an image having such a small size data followed by processing by using the aforementioned detection result will suppress the computation load and thereby enable a high speed processing. The same effect will result for a later described overlapping position detection processing and two-image mutual distortion and expansion/contraction detection processing.

The overlapping position detection unit 12 detects a mutual overlapping position of images for combining the above described two input images by using an image with its distortion having been corrected (“corrected image for distortion” hereinafter) by the image distortion detection unit 11. This almost eliminates a possibility of being unable to detect the overlapping position. A detection method for the mutual overlapping position between the images adopted by the overlapping position detection unit 12 is by the one noted in a Japanese patent laid-open application publication No. 2000-278514 for instance if the input image is a document image. Or any other relevant method may be used. On the other hand, if the input image is a photograph, or a graph, not containing a character, the method noted in a Japanese patent laid-open application publication No. 2002-305647 for instance may be used, or any other relevant method.

The mutual distortion and expansion/contraction detection unit 13 detects a mutual distortion and expansion/contraction of two images in the overlapping area for combining the above described two images. The image distortion for each of the two images is already detected by the above described image distortion detection unit 11. It is, however, highly possible to result in a degradation of image quality of the combined part being affected by displacement of pixels caused by an incomplete matching of two images in the overlapping area even if the respective input images are corrected based on the result of distortion detection. Besides, the image distortion detection unit 11 cannot detect an expansion/contraction of image.

Therefore, it is necessary to detect a mutual distortion and expansion/contraction of the two images. The detection method will be described later herein.

The image correction unit 14 corrects the two input images based on the detection results by the above described image distortion detection unit 11, and mutual distortion and expansion/contraction detection unit 13.

The image superimpose unit 15 combines the two images corrected by the image correcting unit 14 based on the detection result by the overlapping position detection unit 12.

The image distortion detection unit 11 is able to detect/correct a distortion of each image of each input image automatically without a specific comprisal such as a two-dimensional sensor as described above.

Furthermore, the mutual distortion and expansion/contraction detection unit 13 detecting a mutual distortion and expansion/contraction of the two images for the image correction unit 14 correcting the mutual distortion and expansion/contraction within the overlapping area detected by the overlapping position detection unit 12, in addition to the above described image distortion detection unit 11 correcting a distortion of each image individually, makes it possible to suppress a positional displacement of the two images with each other so as to create a combined image in high image quality.

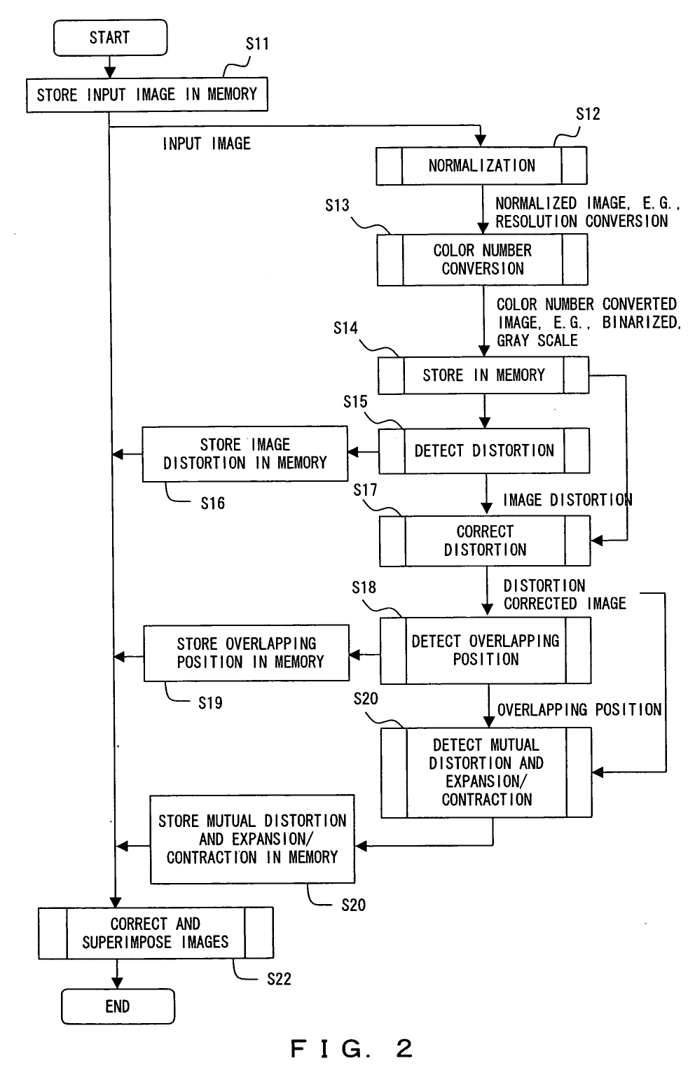

FIG. 2 shows a flow chart for describing a processing procedure of a first embodiment performed by the above noted image combine apparatus 10.

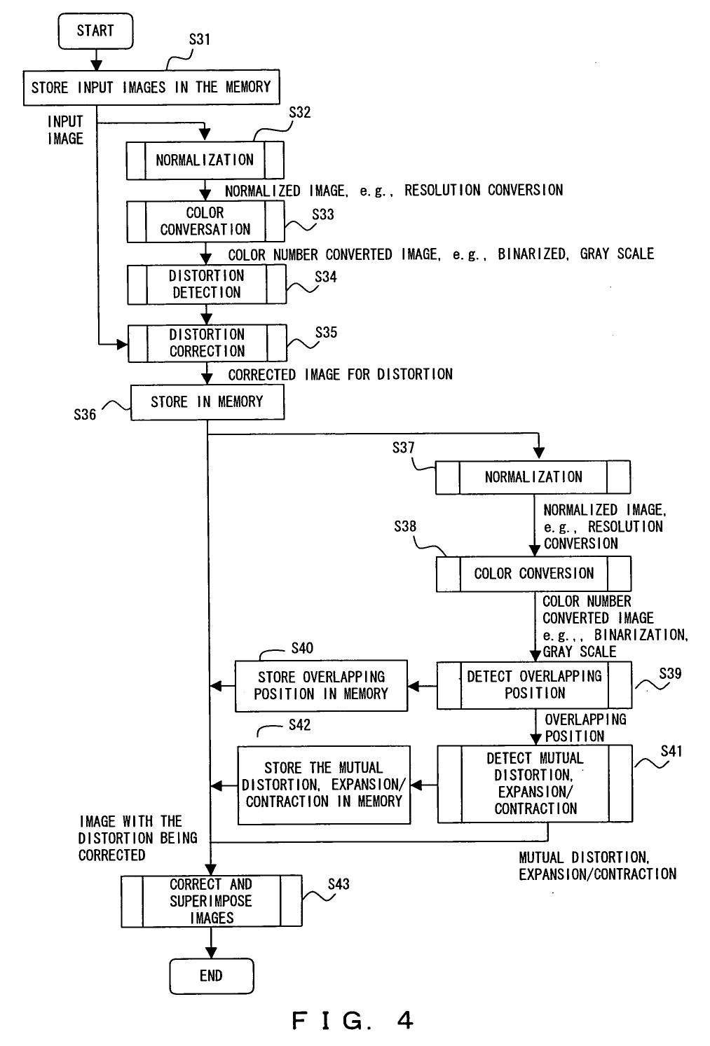

FIG. 4 shows a flow chart for describing a processing procedure of a second embodiment performed by the above noted image combine apparatus 10.

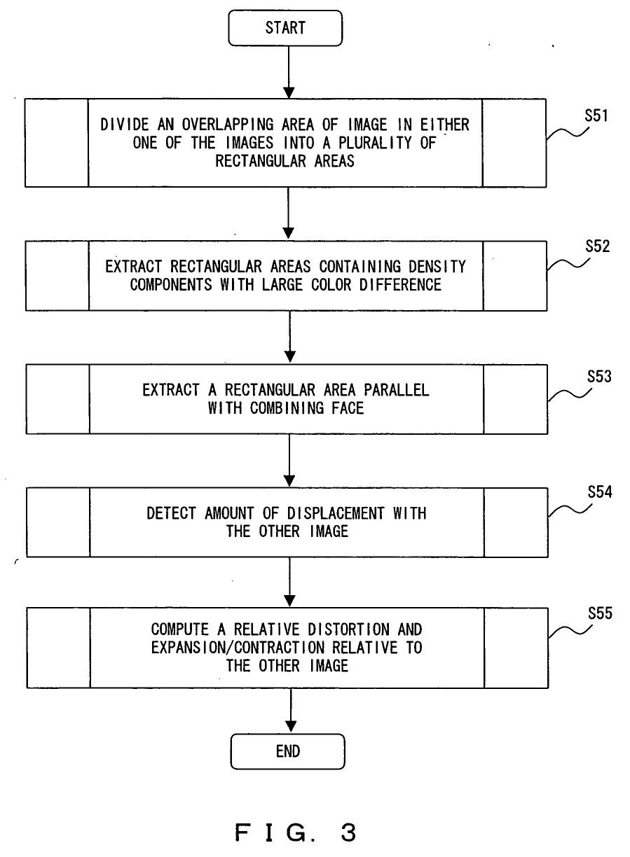

FIG. 3 shows a detailed flow chart of “detection of mutual distortion, expansion/contraction” in the step S20 of FIG. 2 or the step S41 of FIG. 4.

First, a description is given to the processing procedure of the first embodiment by referring to FIG. 2.

Here, the description takes an example method for detecting a distortion of each image, an overlapping position, and a mutual distortion and expansion/contraction of images by using an image of reduced size data, such as the normalization (i.e., reduced image size), binarization, or gray scale of the input image, especially for processing an input image being a color image having RGB components; storing the detection result (i.e., parameters) temporarily in a memory; followed by an integrated processing such as a correction and combination of the input images based on the aforementioned parameters, which makes it possible to reduce the memory size required during the processing while processing in high speed. The embodiment, however, is in no way limited by the example. A normalization of image will not be done unless it is necessary. Or, a binarization may be done as appropriate if the input image is a gray scale image (i.e., gradation image with a single color component). A conversion will not be done if the input image is a binarized image.

First of all, the processing stores, in a memory (e.g., an image buffer), a plurality of input images (i.e., two images picked up partially in two scans herein) being picked up by scanning a scanning object, such as newspaper, drawing or photograph, partially in a plurality of times by using a handheld scanner (step S11; simply a 1a “S11” hereinafter).

Next, creates a reduced size image for each of the input images by the normalization (i.e., reduction) as appropriate (S12). The detection of distortion or overlapping position of an image takes a large amount of processing time and memory size in proportion to the data size of input image, especially for a color image or a high resolution image. If the data size of an input image is large due to a high resolution, reduces the input image geometrically to avoid the problem. One example here is to create a reduced size image by a reduction conversion of an input image. For example, where an input image is Img1 (x, y) and the reduction ratio of 1/n, then the average of the area n (x direction) multiplied by n (y direction) is to be the pixel component.

Meanwhile, if an input image is an image having RGB color components (i.e., color image), creates a converted image (e.g., grayscale image, binarized image) by a color number conversion (S13). The detection of distortion or overlapping position of an image takes a large amount of time and memory size in proportion to the data size of input image. If the data size of an input image is large due to the input image having RGB color components (i.e., color image), converts the input image into a gradation image having a single color component (i.e., gray scale image) or a binarized image to execute the processing such as later described detections of distortion of each image, overlapping position and mutual distortion and expansion/contraction by using the converted image with the data size thus being reduced. A use of such converted image of a reduced size data makes it possible to reduce the computation load while executing the processing in high speed.

Note that either one, or the both, of the above described processing in the steps S12 and S13 may be done for the input image.

An example of method for creating a gray scale image will be described here. If an input image has RGB color components, creates a gradation image by using the YCbCr conversion by focusing on the Y component. Several methods are available such as creating an image having a derivative value as the pixel component by using a differential filter, creating a gradation image having a single color component from among the RGB color components, et cetera. If the input image is a gradation image having a single color component, there is no need for a conversion.

An example method for making a binarized image will be shown here. Creation of a binarized image may use the method noted in a Japanese patent laid-open application publication No. 2001-298625 for instance, or any other relevant methods.

The method noted in the Japanese patent laid-open application publication No. 2001-298625 can simply be summarized as first creating a histogram of densities for an input image obtained by scanning, figuring out a peak value on the high density side and that on the low density side to judge which is higher for each color component, picking up the number of color component whose peak value is higher on the high density side than the low density side and thereby selecting the image for the binarization object image.

In this case, it may be possible to compare the number of color components whose peak value is higher on the high density side with that of color components whose peak value is higher on the low density side to select the color component whose number is large for an image as the object of binarization processing.

For instance, if an input image obtained by scanning is a color image consisting of the three color components of RGB, compares the peak values among the three color components. And if the R and G show higher peak values on the respective high density side, while the B on the low density side for instance, selects the R and G as the images for binarization objects.

Then, compares respective pixel of each of the color components selected as binarization objects with a predetermined threshold level to be able to judge a pixel exceeding the threshold value as either white or black for each color component and the other pixels as the opposite of white or black.

To be specific about the above described example, compares a pixel of the R and G components, respectively, with a predetermined threshold. And if at least one of the R or G component exceeds the threshold value, judge the pixel as white, while neither component exceeds the threshold, then judges the pixel as black, thereby binarizing it.

Alternatively, it may be possible to create a gray scale image, figure out the maximum and minimum values of the gray scale values and make a binarized image by using the intermediate value of the two as the threshold value.

For instance, a document image containing a character is desired to be converted into a binarization image. An image not containing a character, such as photograph and graphics, is desired to be converted into a gray scale image.

And, stores the two input images converted (e.g., gray scale image, binarized image) in the steps S12 and S13 temporarily in the memory (S14). The processing in the steps S15 through S21 described below will use the converted image, making it possible to reduce the computation load and execute the processing in high speed.

The processing in the steps S15 through S21 will be described in the following. Note that the processing in the steps S15, S16 and S17 are basically applied to a document image as the input image, and not to the others. If an input image is other than a document image, the processing in the steps S18 through S21 use the converted image stored in the step S14.

By using the two converted images stored in the above described memory, first detects an image distortion for each converted image (S15). Then, stores the distortion of each image detected in the step S15 in the memory (S16) and, at the same time, corrects the distortion of the converted image based on the distortion of the input image detected in the step S15 (S17). The object of the distortion correction is the converted image, and the final correction of the input image uses the parameter (i.e., a series of detection result) stored in the memory in the step S16.

The distortion detection/correction methods for the image in the steps S15 and S16 use the method noted by the Japanese patent application No. 2001-320620, applied by the inventing entity of the present invention, herein. Other relevant methods may be used.

Let it describe an example of the distortion detection/correction method noted in the Japanese patent application No. 2001-320620 (“the previous application” hereinafter).

Both in the present invention and the previous application, the input image is image data picked up by a handheld image scanner for instance. Such data is made up of many rows of line data along the cross feed direction (i.e., the left to right direction) being arrayed in the feed direction (i.e., the up to down direction).

The image processing apparatus noted in the previous application focuses on the overall structure of data to use the fact that a pair of the one-dimensional line data (i.e., line data) relatively close to each other are not substantially changed from each other. That is, use of a mutual correlation between line data (may be called simply “line” hereinafter) estimates a displacement amount of each line.

For instance, the resolution of the currently used common image scanner falls approximately between 200 to 1200 dpi, in which case the commonly used 12-point character is made up of approximately 33 to 200 pixels. In the case of such number of pixels constituting a character, two lines positioned apart from each other by about 10 pixels are expected to be substantially aligning with each other. Also, a document contains many ruled lines and a series of symbols (such as punctuation marks, parenthesis) with the parts of straight lines further enforcing the characteristic of the above mentioned two lines being aligned substantially.

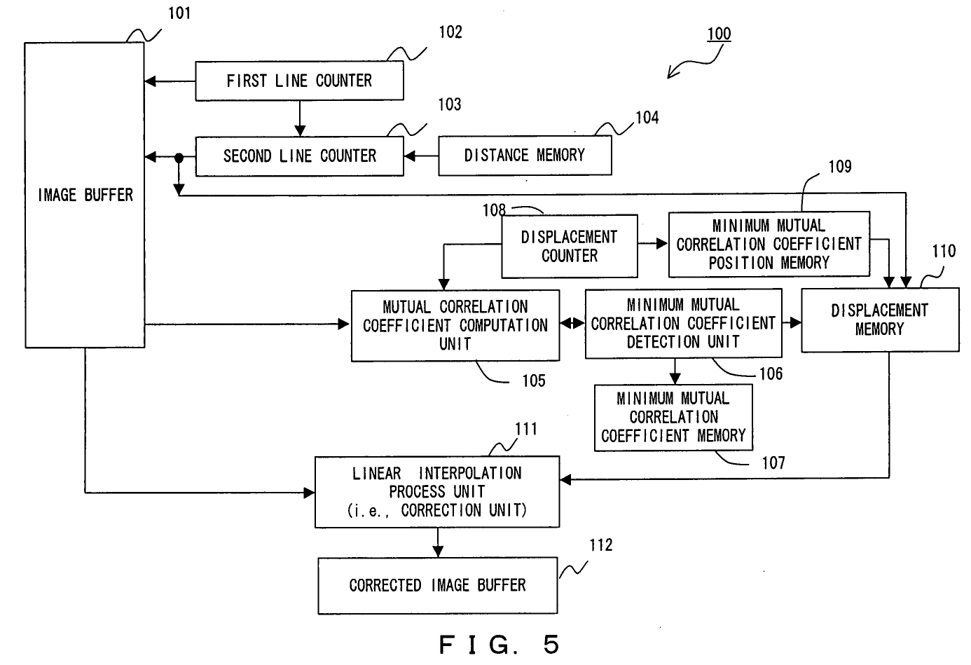

FIG. 5 shows a configuration (part 1) of image processing apparatus 100 comprised by the image distortion detection unit 11, which is approximately the same as the image processing apparatus according to the previous application.

The image processing apparatus 100 shown by FIG. 5 comprises an image buffer 101, a first line counter 102, a second line counter 103, a distance memory 104, a mutual correlation coefficient computation unit 105, a minimum mutual correlation coefficient detection unit 106, a minimum mutual correlation coefficient memory 107, a displacement counter 108, a minimum mutual correlation coefficient position memory 109, a displacement memory 110, a linear interpolation process unit 111 and a corrected image buffer 112.

The image buffer 101 is for storing image data picked up by a handheld image scanner. The image data is made up of many rows of line data along the cross feed direction (i.e., left to right direction; and the direction of one-dimensional line sensor) arrayed in the feed direction (i.e., up to down direction). Note, however, that the image data stored in the image buffer 101 is a converted image stored in the memory in the step S14 following the processing of the above described steps S12 and S13, that is a gray scale image, binarized image, et cetera.

The first line counter 102 and the second line counter 103 are for defining two lines (partial data), as a computation object for a mutual correlation coefficient, which are placed apart from each other by a predetermined interval, and lines according to the values indicated by these line counters 102 and 103 will be outputted from the image buffer 101 to the mutual correlation coefficient computation unit 105. Here, the values out of the line counters 102 and 103 show an n-th line to be read out of the image buffer 101, where the first line out thereof is defined as the zeroth line.

In the distance memory 104, the distance between the above described two lines (i.e., line number corresponding to the distance in the feed direction), d, is preset and the value, d, instructs a distance of line with which a mutual correlation is to be figured out. Then, a value, d, of the distance memory 104 added to a value of the first line counter 102 will be set in the second line counter 103. Therefore, the second line counter 103 specifies the line distanced by a predetermined interval, d, from the specified line by the first line counter 102. The suitable interval, d, incidentally is between 5 and 20, due to a later described reason, and now set at 10. A set value, however, will be different if the input image is reduced by the processing of the step S12. For instance, if the input image is reduced to ½, the interval, d, may be about half of the above noted value (i.e., between 2.5 and 10, approximately).

The mutual correlation coefficient computation unit 105 reads the two line data (i.e., partial data) corresponding to the value set in the line counters 102 and 103 out of the image buffer 101 and calculates a mutual correlation coefficient between the two line data by a later described equation (1). In the process, the mutual correlation coefficient computation unit 105 computes the mutual correlation coefficient when the amount of displacement of the above described two line data in the cross feed direction is equal to a value (i.e., number of pixels), s, set in the displacement counter 108 by the later described equation (1). Specifically, computes the mutual correlation coefficient when the second line specified by the second line counter 103 is moved in the cross feed direction by a value, s, in relation to the first line specified by the first line counter 102. Note that the mutual correlation coefficient calculated by the later described equation (1) shows zero when the first and second lines are identical, and will show a larger number as the similarity between the first and second lines becomes low.

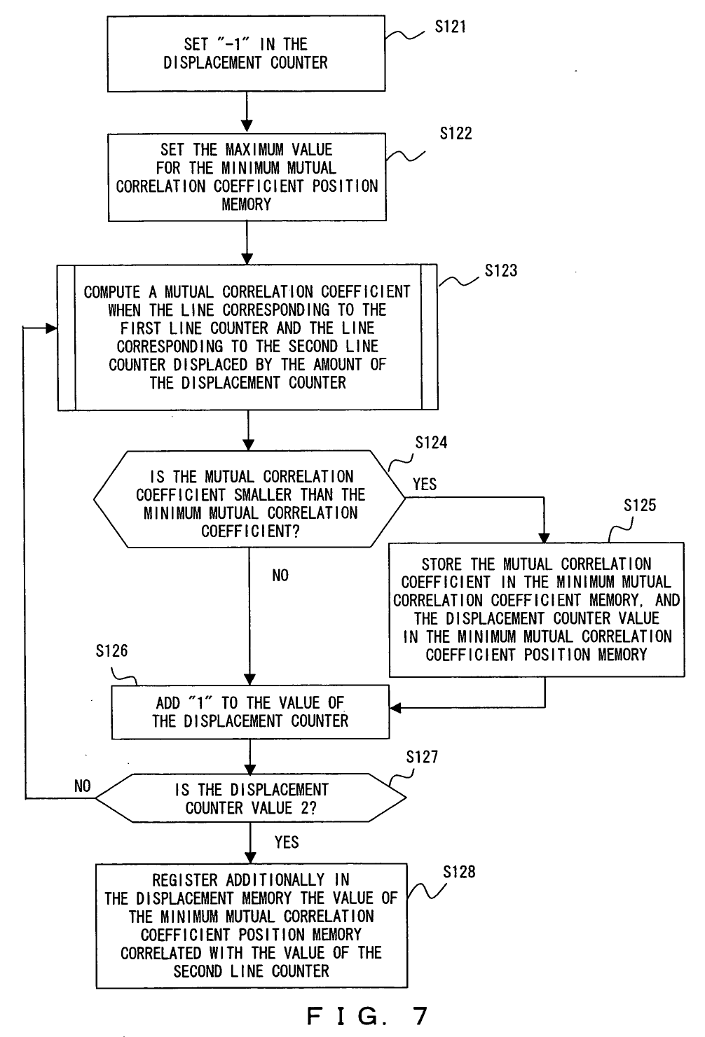

The minimum mutual correlation coefficient detection unit 106 detects a minimum mutual correlation coefficient from among a plurality of mutual correlation coefficients calculated by the mutual correlation coefficient computation unit 105 for each of displacement in a predetermined range (i.e., three values, −1, 0, 1, in the present embodiment as later described). The minimum mutual correlation coefficient detection unit 106 detects and determines the minimum mutual correlation coefficient while using the minimum mutual correlation coefficient memory 107, the displacement counter 108 and the minimum mutual correlation coefficient position memory 109, as described later with reference to FIG. 7.

Here, the minimum mutual correlation coefficient detection unit 106 sets a series of displacement values (i.e., value, s, in the above described predetermined range) to be substituted for the equation (1) sequentially in the displacement counter 108.

Meanwhile, the minimum mutual correlation coefficient memory 107 stores the minimum among the mutual correlation coefficients computed by the mutual correlation coefficient computation unit 105. That is, every time a mutual correlation coefficient is computed by the mutual correlation coefficient computation unit 105 for one particular displacement, the minimum mutual correlation coefficient detection unit 106 compares the newly computed mutual correlation coefficient with the minimum mutual correlation coefficient (i.e., the minimum among at least one of the mutual correlation coefficient being computed previously) stored in the minimum mutual correlation coefficient memory 107 to overwrite the value therein with the newly computed mutual correlation coefficient if the aforementioned mutual correlation coefficient is smaller, otherwise maintain the value already stored in the minimum mutual correlation coefficient memory 107 instead of overwriting it.

The minimum mutual correlation coefficient position memory 109 disposes itself to be written a displacement value (i.e., value, s, in the displacement counter 108), used for computing a new mutual correlation coefficient, as the minimum mutual correlation coefficient position when the new mutual correlation coefficient is overwritten by the value stored in the minimum mutual correlation coefficient memory 107. Therefore, the minimum mutual correlation coefficient position memory 109 stores the displacement value, s, for the mutual correlation coefficient between the above described two lines becoming the minimum at the time when the mutual correlation coefficients are completed computing for all displacement values within the above described range.

And the displacement memory 110 stores the displacement value detected and determined by the minimum mutual correlation coefficient detection unit 106 corresponding to the value of the second line counter 103. In the present embodiment, the displacement memory 110 stores the value, s (that is, the displacement value, s, for the mutual correlation coefficient between the above described two lines becoming the minimum) stored in the minimum mutual correlation coefficient position memory 109, as a result of estimating displacement of the second line in relation to the first line in the cross feed direction, at the time when the mutual correlation coefficients are completed computing for all displacement amounts within the above described range. Note that the following description uses the term “displacement amount”, meaning a displacement amount in the cross feed direction.

When completing computation of the mutual correlation coefficients for all displacement values within the above described range, the first line counter 102 is set newly with the value of the second line counter 103 and, at the same time, the second line counter 103 is newly set with a value by adding the value stored in the distance memory 104 to the newly set value of the first line counter 102. Then, estimates and computes a displacement in the cross feed direction for a pair of new first and second lines. As such, displacement amount in the cross feed direction is estimated for each line data distanced by a predetermined interval, d, for all the image data stored in the image buffer 101 to store the estimation result in the displacement memory 110.

The linear interpolation process unit 111 corrects a displacement of image data so as to eliminate a displacement in the cross feed direction based on the displacement amount written in the displacement memory 110, that is, based on the displacement amount in the cross feed direction estimated as described above, and, more specifically, reads each line forming the image data out of the image buffer 101 sequentially, adjusts and converts the position of the each line in the cross feed direction according to the displacement amount stored in the displacement memory 110 and writes the adjusted data in the corrected image buffer 112.

In the process, the linear interpolation process unit 111 figures out displacement amount in the cross feed direction for each line existing between the above described first and second lines by exercising a linear interpolation based on the displacement amount in the cross feed direction, followed by adjusting the position of each line in the cross feed direction. The specifics of the linear interpolation will be described later.

The corrected image buffer 112 stores a corrected image gained by the linear interpolation process unit 111. The later described processing in the steps S18 and S20 will be done by using the corrected image being stored in the corrected image buffer 112.

Note that the processing “stores image distortion in the memory” in the step S16 shown by FIG. 2 and the above described “stores the estimation result of displacement amount in the cross feed direction in the displacement memory 110” mean basically the same. In the image combine apparatus according to the present embodiment, meanwhile, the stored content (i.e., the result of estimating displacement in the cross feed direction; parameters) of the displacement memory 110 will be retained even after the above described linear interpolation process unit 111 performing a correction processing followed by storing the corrected image in the corrected image buffer 112. The aforementioned stored content will be used for the processing in the step S22.

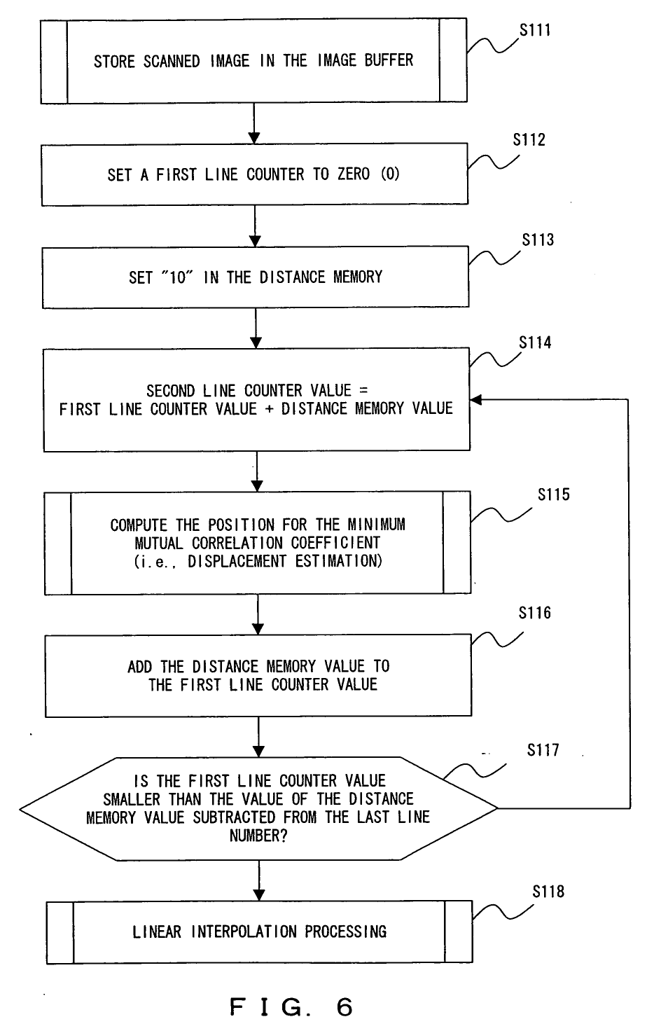

Next description is about an operation of the above described image processing apparatus 100 while referring to FIGS. 6 through 10.

The description is given about an image processing procedure performed by the above described image processing apparatus 100 according to the flow chart (steps S111 through S118).

First of all, the processing of the steps S12 and S13 make a converted image such as gray scale image for each of two images being picked up by scanning a discretionary scanning object partially in a plurality of times (i.e., two times in the present embodiment) by using a handheld image scanner for instance, followed by storing in the memory in the step S14 as described above.

The processing here first stores either one of the two converted images in the image buffer 101 as a processing object (S111).

Let it be assumed here that the image scanner 10 is sidetracked in the left to right direction (i.e., the cross feed direction) during either one of the above described two scanning being associated with the scanning operation by the user, resulting in scanning the area as exemplified by FIG. 45A, and that at least either one of the two input images is distorted.

Then, sets the first line number “0 (zero)” of the image data in the first line counter 102 (S112). Also, sets “10” as the distance, d (i.e., the number of lines), between the two lines as the computation object for a mutual correlation coefficient (S113) in the distance memory 104. Further, sets a number (“10” is the initial number) with the value of the first line counter 102 being added by that of the distance memory 104 in the second line counter 103 (S114).

Subsequently, the mutual correlation coefficient computation unit 105 reads the two lines (i.e., the zeroth and tenth lines, initially) corresponding to the respective values set in the first line counter 102 and second line counter 103 out of the image buffer 101.

Then, computes and estimates the position of the second line relative to the first line when the mutual correlation coefficient of these two lines becomes the minimum as the displacement amount in the cross feed direction (S115) according to a later described processing procedure shown by FIG. 7.

Once estimating the displacement amount, adds the value, d, of the distance memory 104 to the value of the first line counter 102 (S116), followed by checking whether or not the second line as the computation object for a mutual correlation coefficient exceeds the image data size (i.e., the last line) (S117). In the step S117, the checking is for whether or not the newly set value in the first line counter 102 is smaller than the result of the last line number for the image subtracted by the value, d, of the distance memory 104.

If the next second line does not exceed the last line (“yes” in S117), repeats the processing of the steps S114 through S117. When the next second line exceeds the last line (“no” in S117), judging the displacement estimations for the entire area of the image data is complete, then the linear interpolation process unit 111 corrects a displacement of the image data so as to eliminate the displacement thereof in the cross feed direction while performing a later described, common linear interpolation processing based on the displacement amount written in the displacement memory 110 (S118).

FIG. 7 shows a detailed flow chart of displacement estimation processing in the above described step S115.

In FIG. 7, first sets, “−1” in the displacement counter 108 as the initial value for displacement amount of the second line relative to the first line (S121). Here, while the set values, s, (i.e., a range of displacement amount) for the displacement counter 108 are defined to be three values, −1, 0, 1, assuming the maximum displacement amount occurring as about one pixel in the cross feed direction when moving an image scanner for about ten lines, other values may be set, however.

Then, after setting the maximum value possible for the minimum mutual correlation coefficient position memory 109 (S122), the mutual correlation coefficient computation unit 105 computes the mutual correlation coefficient for a pair of lines by using the below described equation (1) when the second line specified by the second line counter 103 is displaced by the value, s, being set in the displacement counter 108 relative to the first line specified by the first line counter 102 (S123). The computation method for the mutual correlation coefficient is common.
[Mutual correlation coefficient]=Σ{VA(i)−VB(i+s)}² (1);
where, in the equation (1), the “1” means a computation of total for i=0 to N−1; N denotes the number of pixels constituting one line; VA(i) is the value of the i-th pixel in the first line specified by the first line counter 102; VB(i) is the value of the i-th pixel in the second line specified by the second line counter 103; and “s” is the above described displacement amount (i.e., the value set in the displacement counter 108). The above equation (1) computes a grand total of {VA(i)−VB(i+s)}² computed for each pixel as a mutual correlation coefficient.

Then, the minimum mutual correlation coefficient detection unit 106 compares the mutual correlation coefficient computed by the mutual correlation coefficient computation unit 105 with the value being set in the minimum mutual correlation coefficient memory 107 (i.e., the past value of the minimum mutual correlation coefficient) (S124). As a result of the comparison, if the newly computed value of mutual correlation coefficient is smaller than the set value in the minimum mutual correlation coefficient memory 107 (“yes” in S124), the minimum mutual correlation coefficient detection unit 106 overwrites the value of the minimum mutual correlation coefficient memory 107 with the new mutual correlation coefficient, and, at the same time, the value, s, of the displacement counter 108 being used for the current computation is stored in the minimum mutual correlation coefficient position memory 109 as the minimum mutual correlation coefficient position (S125). Then, adds “1” to the value of the displacement counter 108 (S126).

On the other hand, if the value of the newly computed mutual correlation coefficient is equal to, or greater than, the set value in the minimum mutual correlation coefficient memory 107 (“no” in S124), then the value in the minimum mutual correlation coefficient memory 107 remains intact, instead of being overwritten. Then, adds “1” to the value in the displacement counter 108 (S126).

Then, judges whether or not the new value (i.e., after adding “1” thereto) in the displacement counter 108 is “2” (S127) and, if not “2” (“no” in S127), repeats the processing of the steps S123 through S127).

Meanwhile, if the judgment is that the new value in the displacement counter 108 is “2” (“yes” in S127), further judges that the processing for the above described displacement amounts, −1, 0, 1, are complete, followed by additionally registering, in the displacement memory 110, the displacement amount being stored currently by the minimum mutual correlation coefficient position memory 109 as the result of estimating the displacement of the second line in the cross feed direction relative to the first line (S128). At this time, the estimated displacement amount in the cross feed direction and the value (i.e., the line number) in the second line counter 103 are correlated with each other in storing in the displacement memory 110.

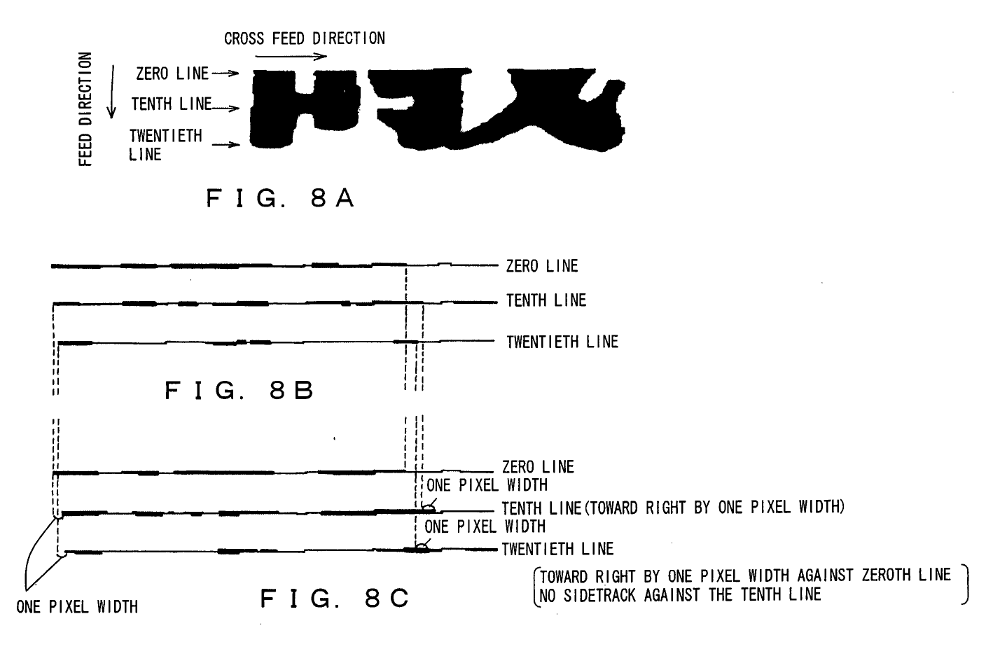

Next, the above described processing will be described more specifically while referring to the examples shown by FIG. 8A through 8C.

FIG. 8A shows an exploded image of a part of image data (i.e., the lower part of a certain Chinese (or, kanji) character) which has been actually picked up by the above described image scanner for instance. The description in the following concerns with the above described image processing method being applied to the image data shown by FIG. 8A.

Line data as shown by FIG. 8B are cut out once every 10 lines of the image data shown by FIG. 8A. FIG. 8B shows three line data, of the image data, in the zeroth (the zeroth line), tenth (the tenth line) and twentieth (the twentieth line), in which the three line data maintain the positional relationship of the image data shown by FIG. 8A in both the cross feed and feed directions.

Then, let it be assumed that, as a result of applying the method described in association with FIG. 7 to the zeroth and tenth lines cut out as shown by FIG. 8B, the mutual correlation coefficient has become the minimum when moving the tenth line to the right by one pixel relative to the zeroth line. Likewise, as a result of applying the method described in association with FIG. 7 to the tenth and twentieth lines cut out as shown by FIG. 8B, the mutual correlation coefficient has become the minimum when the displacement of the twentieth line relative to the tenth line is 0 (zero).

The three line data shown by FIG. 8B are corrected as shown by FIG. 8C according to the displacement estimation result. That is, the tenth line is moved to the right relative to the zeroth line by one pixel, and the twentieth line is moved to the right relative to the zeroth line by one pixel. Note that the above estimation result shows that the twentieth line is not displaced relative to the tenth line, and therefore the twentieth line is moved to the right relative to the zeroth line by one pixel so as not to change the relative position between the tenth and twentieth lines.

Also, the lines existing between the lines (i.e., lines from the first through ninth, and from the eleventh through nineteenth), for which mutual correlation coefficients are computed, will be corrected through subjecting to the straight line interpolation processing (i.e., linear interpolation processing) by the function of the linear interpolation process unit 111 during the above described processing.

For instance, since there is a displacement by one pixel between the zeroth and tenth lines in the example shown by FIG. 8B and FIG. 8C, the zeroth through fifth lines stay is as is and the sixth through tenth lines get moved to the right by one pixel. And since the tenth through twentieth lines are estimated not to be displaced, the eleventh through twentieth lines stay put relative to the tenth line, that is, move to the right relative to the original image by one pixel.

Note that the interval of (i.e., distance between) two lines, d, as the object of computation for a mutual correlation coefficient is ten lines (i.e., 10 pixels in the feed direction) in the present embodiment, which is for the following reasoning.

The experiments conducted by the inventor of the present invention and the associates have discovered that, when a person operates a handheld image scanner with the conscious effort for maintaining a straight scanning direction, a displacement occurring in the image data picked up by the handheld image scanner in the cross feed direction becomes approximately one pixel for every 10 lines (i.e., 10 pixels) in the feed direction.

Therefore, a value in the range of 5 to 20, preferably about 10, for the interval, d, of two lines is set as the computation object of a mutual correlation coefficient in the present embodiment. If the interval, d, is less than 5, a detection of displacement in the cross feed direction becomes impossible. Conversely, if the interval, d, exceeds 20 and approaches 100 for instance, a mutual correlation coefficient for two lines without a correlation will possibly be computed, negating an effective estimation of displacement. Note, however, that if a reduction image is the converted image, an appropriate value for the interval, d, will be different depending on the content of reduction.

As such, the image processing apparatus makes it possible to correct an displacement of image data (i.e., one-dimensional distortion) by using the picked up data only, without the help of a two-dimensional sensor. For instance, even if a handheld image scanner is sidetracked in the cross feed direction (i.e., the line sensor direction) during the scanning operation as shown by FIG. 45A resulting in a distortion (i.e., displacement in the cross feed direction) of the image data, it is possible to eliminate the distortion to gain distortion free, image data of a high image quality. Therefore, it is possible to obtain distortion free, image data of a high image quality, without ushering in a manufacturing cost increase.

Meanwhile, estimation of displacement in the cross feed direction based on a mutual correlation between line data sequentially extracted by an appropriate interval in the feed direction enables the computation load for estimating the displacement in the cross feed direction to be so reduced as to not only perform the image correction processing efficiently, but also improve the computation accuracy of the displacement in the cross feed direction.

In the processing, a displacement for each line data existing in between the line data having an appropriate interval between them is computed by the linear interpolation process unit 111 performing a linear interpolation processing based on the displacement in the cross feed direction so that the image data is corrected based on the result thereof. Then the displacement in the cross feed direction estimated for an appropriate interval, d, is allocated linearly to each line data so as to correct the image data smoothly.

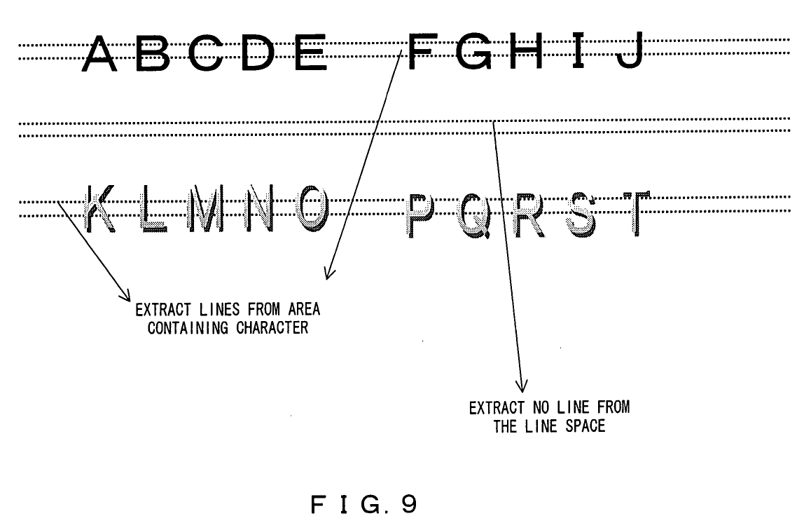

The two line data as the computation object for the above described mutual correlation coefficient are extracted from an area containing a character, and not from a line space, in a document image for instance as exemplified by FIG. 9. In order to extract from an area containing a character, a frequency component of the image is figured out for instance, and a line data containing a certain amount of a certain frequency component is extracted. A character area contains a large number of high frequency components with a large amount of characteristic, whereas a line space contains a large number of low frequency components with a small amount of characteristic. And an area containing high frequency components shows a remarkable difference in the mutual correlation values, making it possible to detect an accurate displacement amount.

Furthermore, while not shown in FIG. 5, an addition of smoothing process unit to the configuration shown by FIG. 5 may be appropriate.

A smoothing process unit (not shown) will be equipped between the displacement memory 110 and the linear interpolation process unit 111 so as to perform a smoothing processing in order to make the displacement amounts in the cross feed direction estimated in a predetermined interval, d, by the above described step S115 line up along a smooth curve based on the displacement amounts in the cross feed direction stored in the displacement memory 110 and output the smoothed displacement amounts in the cross feed direction to the linear interpolation process unit 111.

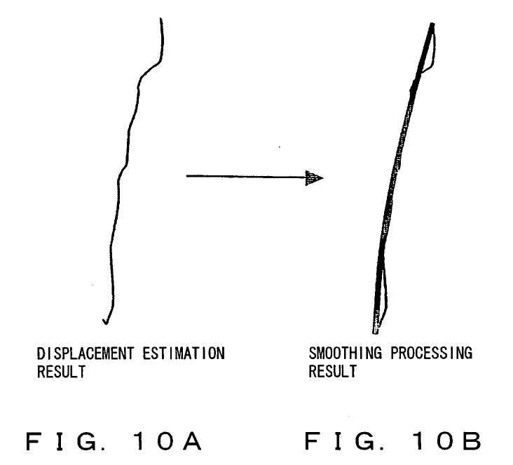

A smoothing processing is now described by referring to FIG. 10A and FIG. 10B. Note that the displacement amount, either “−1”, “0” or “1”, in the cross feed direction stored in the displacement memory 110 is the displacement between two lines in a predetermined interval. FIG. 10A shows a result of figuring out displacement in the cross feed direction relative to the original image by integrating (add up) sequentially a plurality of displacement amounts in the cross feed direction being stored in the displacement memory 110 and a delineation of the resultant positions along the feed direction. Meanwhile, FIG. 10B shows a result of the smoothing process unit 113 performing a smoothing processing for the displacement amounts in the cross feed direction shown by FIG. 10A.

An estimation result of displacement in the cross feed direction actually computed shows small irregularities as shown by FIG. 10A in many cases. The cause of the irregularities is largely affected by the image itself, instead of a scanning operation by the user creating such irregularities.

The smoothing process unit 113 then smoothes the estimation result shown by FIG. 10A so as to line up along a smooth curve as shown by FIG. 10B, which will be used for a linear interpolation and a correction. The method for such smoothing can adopt a common method such as a method using the moving averages, a Bezier curve, and an approximation by quadratic function. A Bezier curve is commonly expressed by a later described equation (4).

As described above, the processing of the step S111 performs the above described processing for either one of the two converted images as the processing object to detect a distortion of the converted image as the processing object, stores the detected distortion, corrects the image based on the distortion detection result and stores the corrected image, followed by performing the above described processing likewise for the other converted image as the processing object to detect a distortion of the other converted image, stores the detected distortion, corrects the image based on the distortion detection result and stores the corrected image.

Then performs the processing in the steps S18 through S21 shown in FIG. 2 by using these two corrected images, as described in the following.

First, detects a mutual overlap area (i.e., position) of the above described two corrected images (S18).

The processing, if the input image is a document image, adopts the method noted in a Japanese patent laid-open application publication No. 2000-278514, or may adopt another method. If the input image is one not containing a character, then adopts the method noted in a Japanese patent laid-open application publication No. 2002-305647, or may adopt another method.

Also, if the input image is a document image, performs the processing in the step S18 by using the corrected image in the step S17. Meanwhile, if the input image is other than a document image (e.g., photograph, drawing), performs the processing in the step S18 by using the converted image stored in the memory as a result of the above described step S14.

Let it be explained briefly the methods noted in the Japanese patent laid-open application publications Nos. 2000-278514 and 2002-305647.

First, according to the method noted in the Japanese patent laid-open application publication No. 2000-278514, for instance, a character area detection unit figures out the coordinates of each character area (e.g., the coordinate of the top left corner and the size) in a line image every time it extracts a line image (i.e., an image in the area circumscribing a plurality of character images constituting one line of a document) for each of a first and second document images picked up partially in two times by using a scanner to notify to the overlapping position detection unit. A character area denotes an area surrounded by rectangles circumscribing a character.

The overlapping position detection unit performs a character recognition for a character area of the line image for each of the first and second document images to acquire the corresponding character code, compares the character code, and the position and size of the character area between the two document images, judges the position of the line image with a high degree of similarity in the character code, the size and position, as the overlapping position of the document images, and outputs for instance the coordinate of the heading character area of the highly similar line image and that of the last character area as the overlapping position coordinates. The coordinates of the overlapping position are stored the memory in the step S19. While the Japanese patent laid-open application publication No. 2000-278514 also discloses a method by not performing a character recognition, there is a probability of displacement of character area positions (since there is a possibility of incomplete distortion correction after the distortion correction processing in the step S17) even between the line images at the overlapping position due to the image distortion in the present embodiment, it is desirable to judge by comparing the character recognition result in order to eliminate a possibility of being unable to detect an overlapping position just by using the position and size of the character area. This of course depends on the condition of the corrected image after the distortion correction processing in the step S17.

Next, the method noted in the Japanese patent laid-open application publication No. 2002-305647, first, converts each of two input images (e.g., color image) into a gradation image (i.e., gray scale image) having a single color component, further converts it into an image (reduction image) with a much reduced data size, and detects an approximate overlapping position by using the reduction image. The conversion method for the gray scale image has been described above. Then, detects a correct overlapping position by using the above described gray scale image, in which divides the detected approximate overlapping position into a plurality of rectangular areas to use the rectangular area containing many density components with a large color difference for detecting a correct overlapping position whereas the rectangular area containing many density components with a small color difference for a combining face (i.e., seam) of the two images. Stores these detection results such as the overlapping position and the combining face temporarily in the memory as parameters (processing of step S19). These parameters will be used for a later described image combination processing (i.e., superimpose) using the two input images.

Note also that the rectangular area containing many density components with a large (small) color difference reduces each rectangular area and emphasizes lines and edges in the image by subjecting the reduced image to a differential filter, for instance. And a rectangular area having the number or length of the line or edge either for at least a first threshold number or no more than a second threshold number is distinguished as a rectangular area containing many density components with a large (small) color difference.

According to the method noted by the above described Japanese patent laid-open application publication No. 2002-305647, an input image with a large data size (e.g., color image) is only used in the last processing, preceded by processing such as detecting the overlapping position by using the image with a small data size (e.g., reduced image, gray scale image), thereby accomplishing a high speed processing while suppressing the memory size required for the processing.

Then, if the input image is a document image, detects a mutual distortion or expansion/contraction of two images by using the converted image corrected in the above described step S17 and the position of a mutually overlapping area between the two corrected images detected in the step S18. If the input image is some other than a document image (e.g., photograph, drawing), detects a mutual distortion or expansion/contraction between the two images by using the converted image stored in the memory in the above described step S14 and the position of mutual overlapping area between the two images detected in the step S18 (S20).

FIG. 3 shows a detailed flowchart of the processing in the step S20 for an input image being some other than a document image; also, a detailed flow chart of a later described processing in the step S41 of FIG. 4 for an input image being some other than a document image.

In FIG. 3, note that the processing in the steps S51 through S53 is actually done during the processing of the step S18, if the above described processing of the step S18 has been done by the method noted by the Japanese patent laid-open application publication No. 2002-305647, only requiring to use the result. So the processing in the steps S51 through S53 is not necessary, but let it describe not only in duplication but also in more detail by using an actual example.

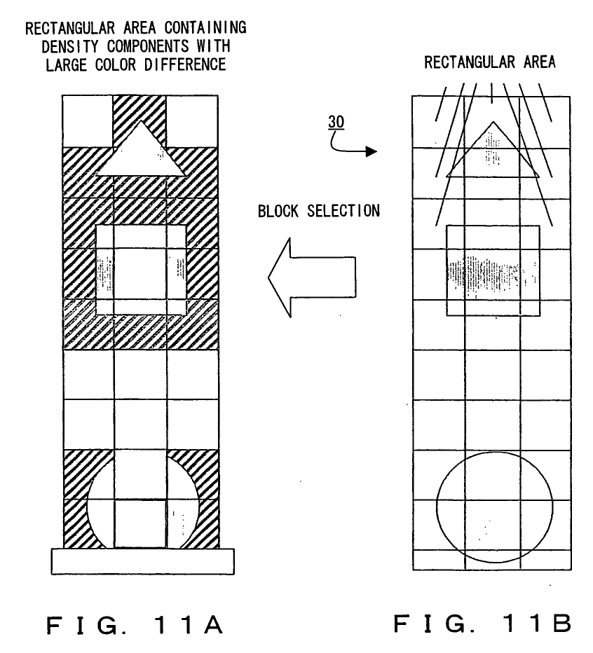

First, divides an overlapping area of image in either one of the two converted images into a plurality of rectangular areas (S51); into a rectangular areas made up of M-lines by N-rows (as exemplified by FIG. 11A) in this case.

Then extracts rectangular areas containing many density components with a large color difference (“first rectangular area” hereinafter) (S52), which is performed by subjecting each rectangular area to a differential filter to emphasize the lines and edges within the image. Then, performs a contour line chasing for extracting an area as a first rectangular area if the area contains at least a certain number of lines or edges with at least a certain length thereof. That is to extract “a rectangular area containing many density components with a large color difference” by using the method noted in the Japanese patent laid-open application publication No. 2002-305647.

Since color differences become large in the border parts with the background, person, mountain, tree, river, et cetera, in an actual photograph, et cetera, the rectangular areas containing such color components will be extracted as the first rectangular areas. In the example shown by FIG. 11A, the rectangular areas shaded by diagonal lines in FIG. 11B are extracted as the first rectangular areas.

Note that the extraction method is not limited to the one based on the above noted color difference, but also by the difference of luminance to select the first rectangular area having a large difference thereof for such image using a luminance component.

Then, selects a plurality of rectangular areas in the direction parallel with the combining face from among the first rectangular areas extracted in the step S52 (S53), in which the selection will be even from wide areas within a row rather than being biased to either the top or bottom half.

An image matching by using a rectangular area with a large color difference causes a large difference between a correct overlapping area and the other areas. For instance, in a matching method using the Hamming distance or Euclid distance, the value becomes small at a correct overlapping position, otherwise the value becomes large. Hence the first rectangular area extracted in the step S52 is suitable to use for detecting an accurate overlapping position. All of them are, however, not necessary to be used, some will be selected from among them accordingly in the step S53.

The processing in the step S53 selects rectangular areas for detecting an accurate overlapping position from among the first rectangular areas extracted in the step S52 for instance in the direction parallel with the long side of the overlapping position detected in the above described step S18.

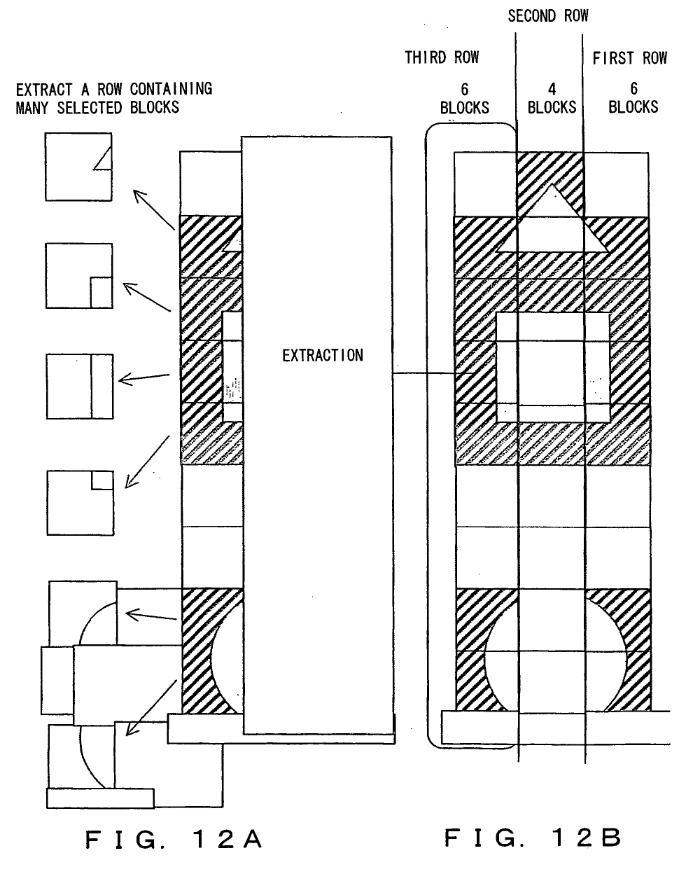

If the processing is done for the example shown by FIG. 11B, extracts each row between the first and third rows as shown by FIG. 12A, selecting a row containing the largest number of the first rectangular areas in such a case.

If there are a plurality of rows containing the largest number of the first rectangular areas as in the example shown by FIG. 12A having two rows, i.e., the left and right rows having the same number, six, of the first rectangular areas, either one of the two rows will be selected. In this example, the third row is selected as shown by FIG. 12B.

If, however, there are fewer number of the first rectangular areas being contained in the selected row (e.g., a predetermined criteria is seven or greater), the selection will be done from other rows as well. Consequently, it is possible to increase the processing time for matching by using the first rectangular areas selected from a plurality of rows, ending up with too many rectangular areas for detecting an accurate overlapping area. Therefore, selection of more than one rectangular area from a single line will be avoided.

On the other hand, if the selected row contains too many of the first rectangular areas, or there is a need to further reduce the processing time, the number of rectangular areas containing in the row may be reduced. Such selection for reducing the number of the first rectangular areas will be done so as not to be biased toward either the top or bottom half (by scattering evenly from the top to bottom as shown by the figure).

Having selected the rectangular areas used for matching, detects a displacement amount between each of the selected plurality of rectangular areas and the other image (S54) which tries to match by moving each rectangular area in the directions of the left, right, forward and backward by one pixel each from the overlapping position (i.e., initial position) detected in the step S18 for instance. The matching uses a mutual correlation for instance. That is, using a Hamming distance or a Euclid distance to take the position where the distance becomes the minimum as the “conforming position.” Then, detects the displacement between the conforming position and the initial position, followed finally by plotting the displacement amount detected for each rectangular area in the x-y chart to compute a relative distortion with the other image as the basis or an expansion/contraction of the applicable image (S55).

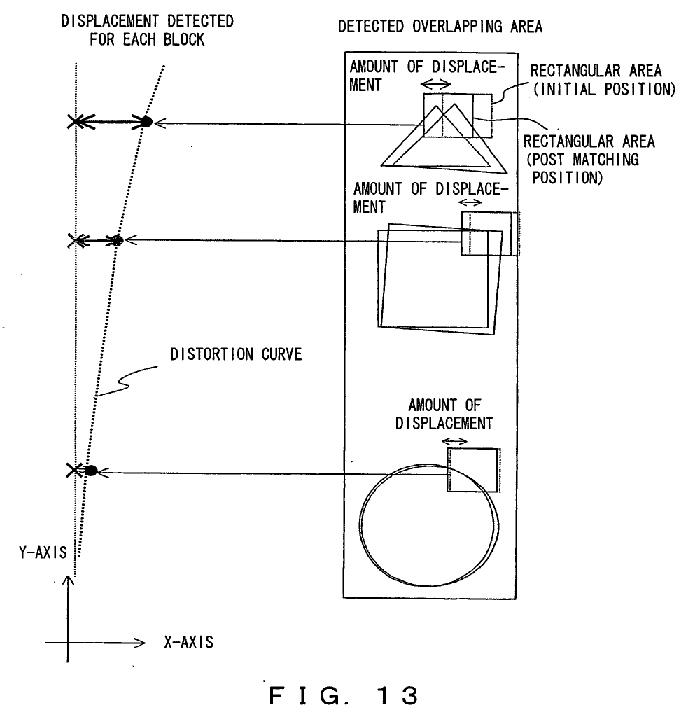

An example is shown in FIGS. 13, 14 and 15.

FIGS. 13, 14 and 15 show apart of rectangular areas (i.e., rectangular areas used for matching) selected from the above described first rectangular area, and these rectangular areas are delineated by dotted lines for the initial position, and by solid lines for the above described “conforming position.” There is a displacement between the initial position (i.e., rectangle by dotted lines) and the “conforming position” (i.e., rectangle by solid lines) as shown by the figures.

In the example of FIG. 13, there is a displacement only in the x-axis direction and not in the y-axis direction. This displacement is plotted in an x-y coordinate as shown in the left side of FIG. 13. The plotting position is the center of each rectangular area, for instance, and the central coordinate of each rectangular area for the initial position is indicated by the mark, ●, while the central coordinate thereof for the “conforming position” is indicated by the mark, x. This gains a distortion curve (or, more precisely, a sequential line graph) shown by the dotted line in FIG. 13. The data indicating the above described x-y plotting positions and data for the distortion curve are stored in the memory in the step S21.

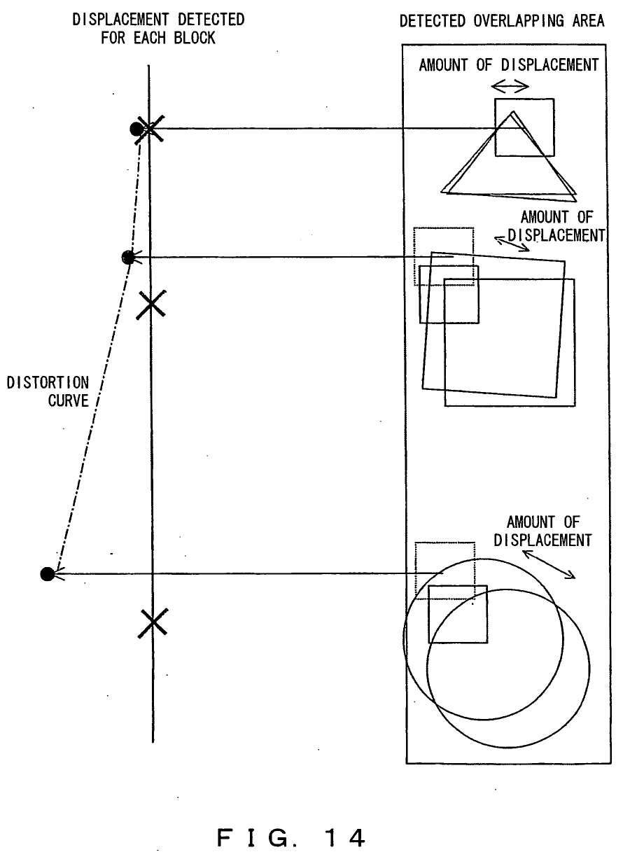

FIG. 14 is similar, except that there is a displacement in not only x-direction but also y-direction, gaining a distortion curve (or more precisely a sequential line graph) as shown by the chain line in FIG. 14.

Meanwhile, if there is a displacement in the y-direction only, and not in the x-direction (including a case where the displacement amount is within a predetermined number, in addition to no-displacement), the judgment is that there is an expansion/contraction, then stores data indicating the plotting position in the above described x-y coordinate in the memory in the step S21.

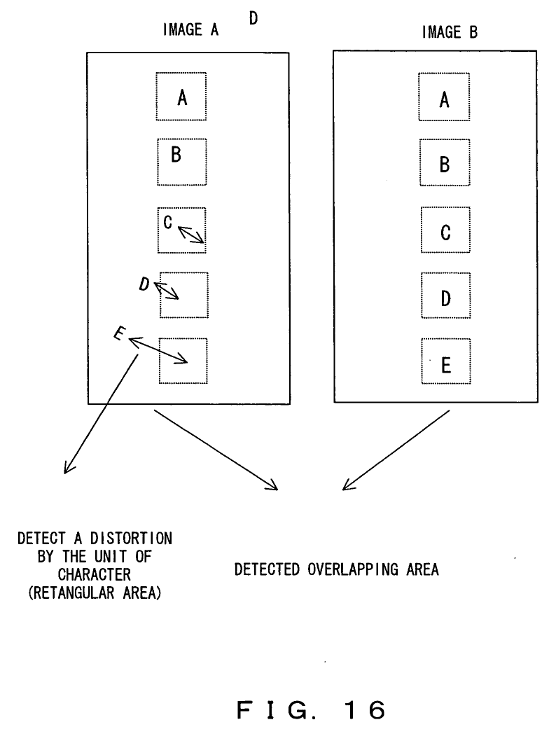

Next up is the description of the processing in the step S20 or S41 for the input document being a document image. While detail of the processing is not specifically shown by a figure, compares the character code and the position and size of each character area by using the method noted by the Japanese patent laid-open application publication No. 2000-278514 in the processing of the above described step S17 to judge the position of the line image with the highest conformity in the aforementioned comparison as the overlapping position for the document images. Here, detects a mutual displacement based on the position and size of each character area within the line image with the highest conformity. That is, performs a matching by the unit of the character area. The matching method may adopt a character recognition, et cetera, in addition to a mutual correlation. FIG. 16 shows a practical example.

In the example shown by FIG. 16, let it be assumed the character string within a line image at the overlapping position detected by the processing of the step S17 is “A B C D E”, for which the image B is normal and the image A is in distortion. Also, the rectangles delineated by the dotted lines in the figure indicate the position and size of each character area (i.e., rectangular area) in the image B. Also for comparison, the rectangles delineated by the dotted lines in the figure indicating the position and size of each character area (i.e., rectangular area) of the image B are shown for the image A as well.

A character area is a rectangle area which are subjected to the matching processing by each thereof (i.e., rectangular area) to figure out a displacement for each character area, plot the coordinate of the center of the character area, further figure out a distortion curve and store these figured out data in the memory in the step S21, the same as in the examples shown by the above described FIGS. 13, 14 and 15. Alternatively, a displacement of the position of rectangular areas between the same characters may be figured out by using a character recognition result (if there are a plurality of the same characters, one in closer distance will be adopted).

Then stores, in the memory, the data indicating the mutual distortion and expansion/contraction of the images, that is, the above described plot position and the distortion curve data, detected by the processing shown by the above described FIG. 3 (S21).

Then finally, performs a superimpose processing at the detected overlapping position by using the two input images (color image) stored in the memory in the step S11, while correcting the distortion and expansion/contraction of the two input images by using the series of parameters stored in the memory in the steps S16, S19 and S21 (S22). The parameter used for the distortion and expansion/contraction is the value stored in the memory in the steps S16 and S19; and the parameter used for the overlapping position is the value stored in the memory in the step S21.

The correction method for a mutual distortion of images uses for instance the one noted by the previous application, in which the method detects a distortion in the unit of line data and corrects the distortion in the unit thereof. Whereas the present embodiment detects a distortion in the unit of rectangular area or character area as described above.

The method of the present embodiment, however, can adopt the above or below mentioned method noted in the previous application. That is, the method of the present embodiment figures out a distortion curve (i.e., a sequential line graph) based on a displacement for each rectangular area to store in the memory as the distortion detection result, as described in reference to FIGS. 13 and 14. Therefore, a use of the distortion curve makes it possible to figure out a distortion amount of each line data, which in turn correct the distortion by applying the method noted in the previous application. The other method may be used of course.

In the meantime, let it describe the expansion/contraction which the method noted in the previous application has not dealt with.

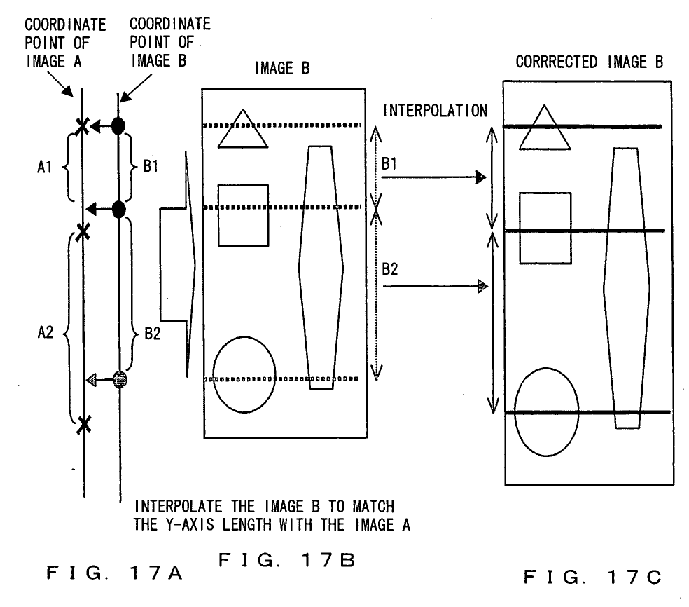

If an expansion/contraction has occurred in either one of the two input images, performs an interpolation processing by adjusting the image in expansion/contraction to the other normal image as shown by FIG. 17A through 17C. An expansion/contraction is caused when a part of the line data is missed for some reason as described above. Therefore, it is necessary to compensate for the missing part.

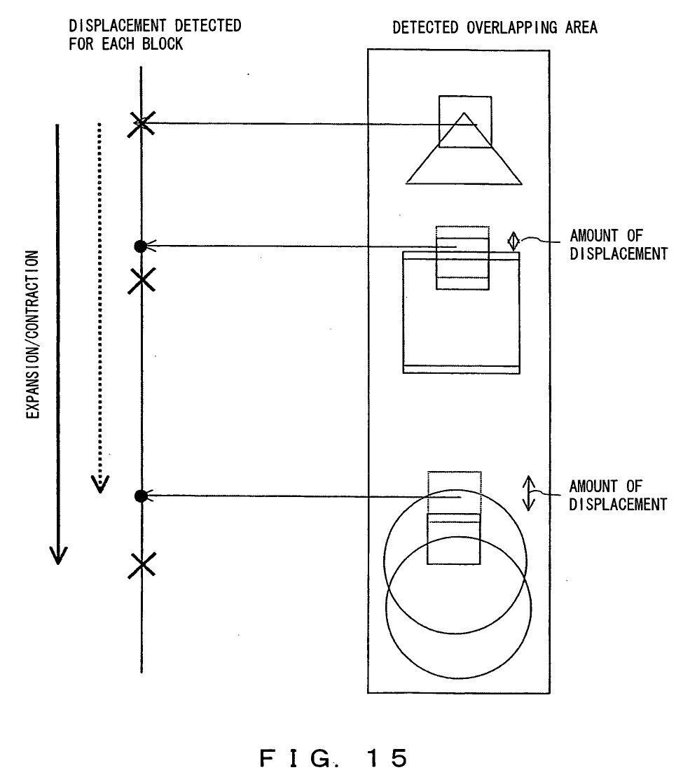

First, the processing in the step S20 or S41 plots the coordinate of the center of the initial position and “conforming position” of each rectangular area in the x-y graph, followed by storing the data in the memory, as described for the above mentioned FIGS. 13 through 15. If there is an expansion/contraction, plots the coordinates shown by marks, x and ●, as shown in the left side of FIG. 15. Reads this out as shown by FIG. 17A. As with images in expansion/contraction being always contracted in the y-direction, the image B is in expansion/contraction, being the object of interpolation, in the example shown by FIG. 17A.

First, divides the image B into a plurality of areas with the coordinate of the mark, ●, of the image B as the border. By this, dividing the image B with the dotted lines as the borders as shown by FIG. 17B gains the two divided areas with the length in the direction of y-axis being B1 and B2, respectively.

Then, performs an interpolation processing for the each divided area, by using an interpolation rule, either a straight line or spline interpolation.

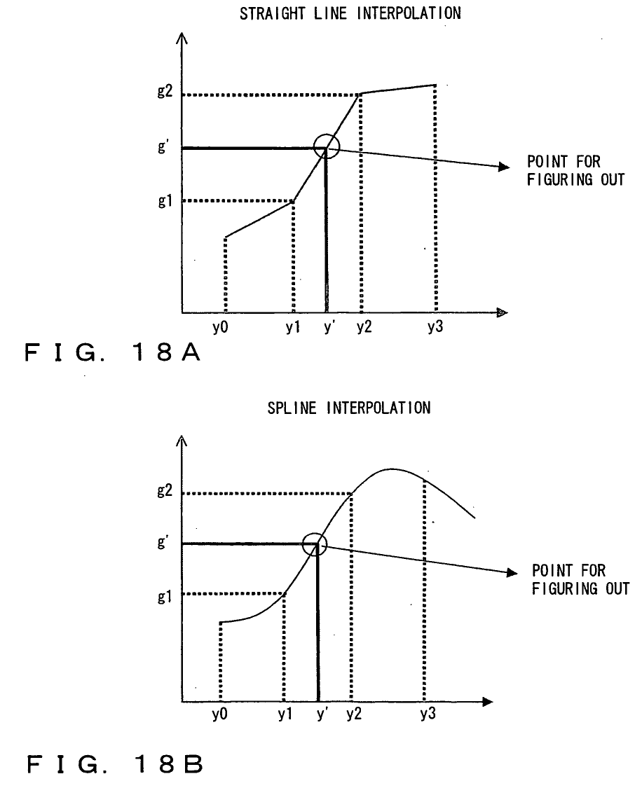

If the expansion/contraction ratio for the divided area with the length in the direction of y-axis being B1, that is, A1÷B1=1.5, and if the number of pixels is ten for one row in the y-direction of the divided area for instance, then the number of pixels becomes fifteen for one row in the y-direction of the corrected image shown by FIG. 17C. The interpolation processing for this example, first, figures out a graph by using the above described rule. The graph is a sequential line graph as shown by FIG. 18A for a straight line interpolation, while a curve graph as shown by FIG. 18B for a spline interpolation. Then figures out fifteen grid points and the pixel values by taking samples once again based on the graph to use them for an image interpolation.

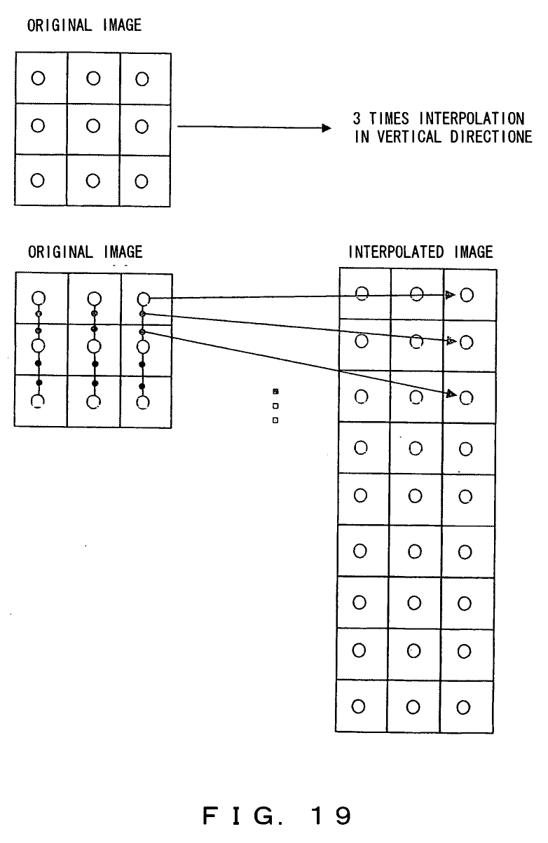

FIG. 19 shows another example of interpolation processing in which the image in expansion/contraction is contracted to one third of the original image. The interpolation processing divides the image in expansion/contraction into a plurality of rectangular areas, figures out the coordinate of the center of each rectangular area and obtains the grid point between the each center point in the y-axis direction (N.B: since this case enlarges to 3 times, obtains two grid points between the respective center points). Obtains the grid points based on the above described sequential line graph or curve graph for instance. Another method may be used. Then, creates an interpolated image with the obtained grid points becoming the center of the respectively new rectangular areas as shown by the figure.

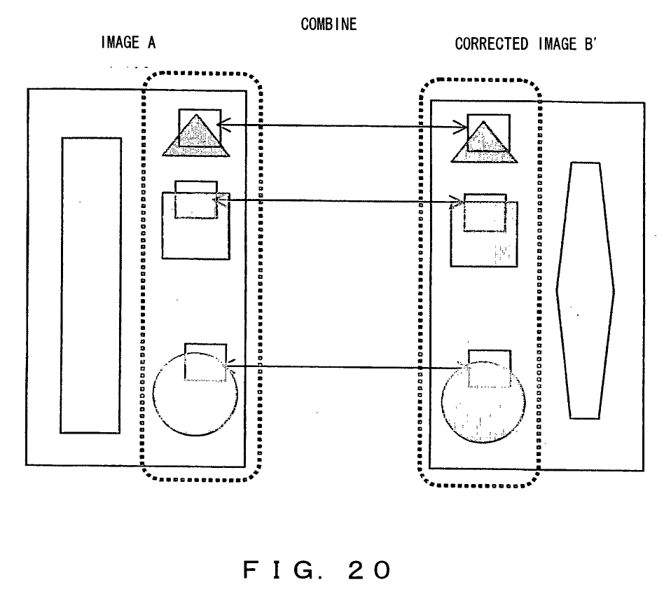

Having corrected the distortion and expansion/contraction of the image, superimposes (i.e., combines) the two images by using the corrected images as exemplified by FIG. 20.

Meanwhile, the superimpose method for the images, if they are document images, uses the method noted in the Japanese patent laid-open application publication No. 2000-278514 for instance. Or, may use another relevant method. If the input images are the ones not containing a character (e.g., photographic, graphic and drawing images), uses the method noted in the Japanese patent laid-open application publication No. 2002-305647 for instance.

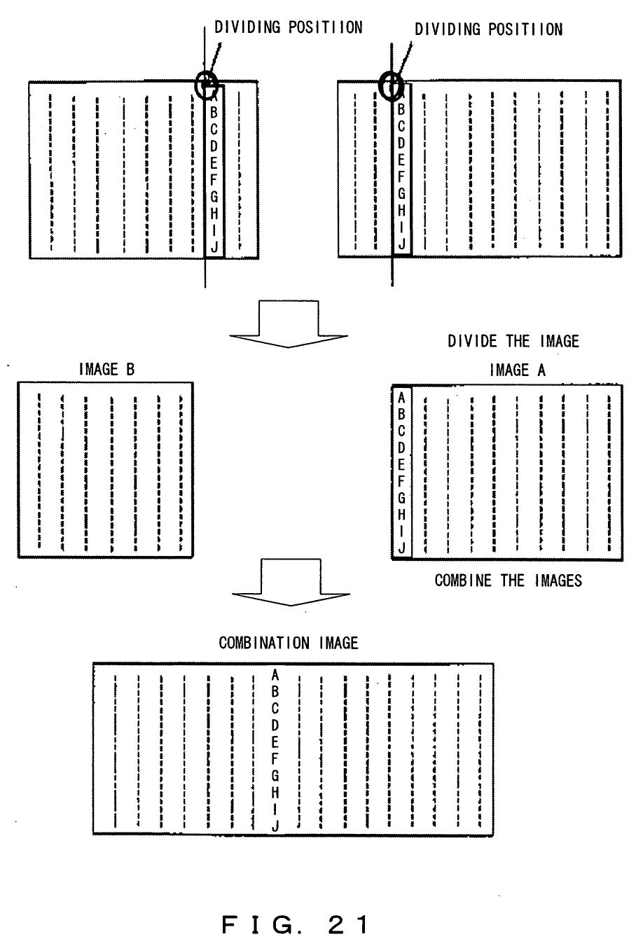

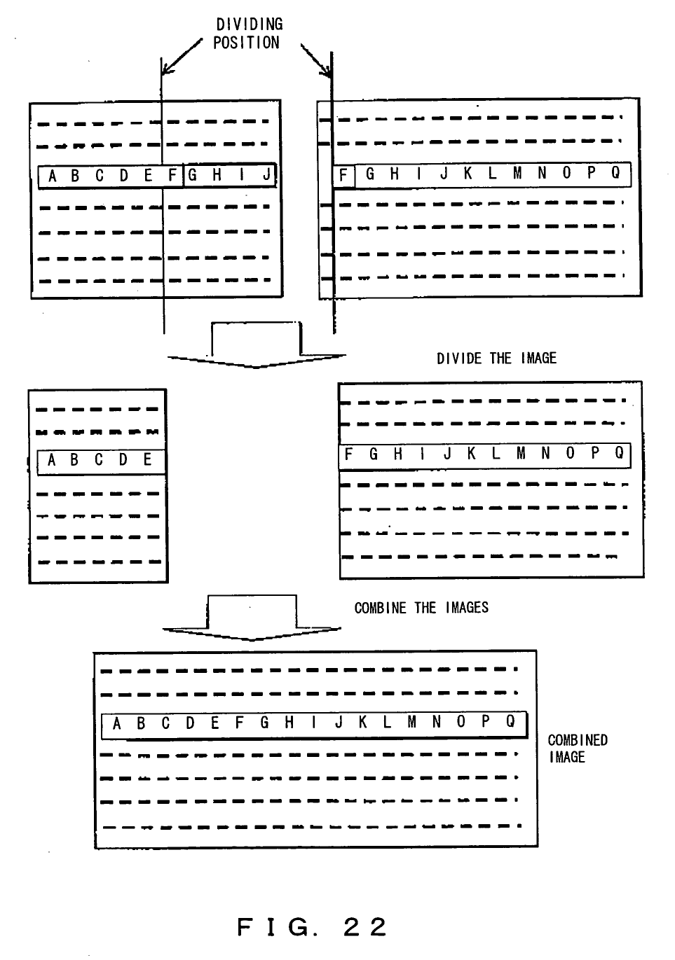

The method noted in the Japanese patent laid-open application publication No. 2000-278514 for instance uses the method shown by FIG. 21 for instance, if the combining face is parallel with the line, and the method shown by FIG. 22 for instance, if the combining face is vertical to the line.

FIG. 21 describes a combination method for document images whose combining face is parallel with the line, that is, the scanning direction is parallel with the line of document image.

The line of character string “A B C . . . ” in a first document image and the line of character string “A B C . . . ” in a second document image are detected as the combining positions to set the coordinate of the top left corner of the applicable image lines in the first and second document images as the coordinate of the combining position. Then, divides the first and second document images into the left part of the coordinate of the combining position and the right part thereof, respectively, and combines the image A, which is the remainder of the first document image with the left side of the dividing position (i.e., combining position) being removed, and the image B, which is the remainder of the second document image with the right side of the combining position being removed to regenerate the original document image.

FIG. 22 describes a combination method for document images whose combining face is vertical to the image lines, that is, the scanning direction is vertical to the line.

In this case the obtained respective dividing positions are the line which runs down vertically to the image lines from the top left corner of the character “F” of the character string “f G H I J . . . ” in the first document image and the line which runs down vertically to the image lines from the top left corner of the character “F” of the character string containing “F G H I J . . . ” in the second document image. Then combines the image A, which is the remainder of the first document image with the left side of the line running at the top left corner of the character “F” being removed, and the image B, which is the remainder of the second document image with the right side of the line running at the top left corner of the character “F” being removed, to regenerate the original document image.

Meanwhile, the method noted in the Japanese patent laid-open application publication No. 2002-305647 for instance, first, extracts not only the above described areas with a large color difference (i.e., first rectangular area) but also a rectangular area containing many color components with a small color difference (“second rectangular area” hereinafter) during the processing in the above described step S18. This is for emphasizing lines and edges within an image by reducing each second rectangular area to “1/NS” and subjecting the reduced image to a differential filter, as with the first rectangular area. Then, extracts an area having a certain number or less of the lines and edges whose lengths do not exceed a certain value as a rectangular area for a candidate area used for a superimpose face. Note that the above mentioned “certain number, (or value)” is a predetermined number or value which is different (i.e., much smaller) from the certain number for the first rectangular area.

It is highly possible to extract a part with a small color difference such as a background color in an actual photograph, et cetera.

Then, the method selects basically one of the second rectangular areas for each line from among the second rectangular areas as the candidate areas used for the superimpose face to store in the memory as a rectangular area used for the superimpose face.

Then, superimposes the two images by using the rectangular area used for the superimpose face in the processing of the step S22.

If a distortion or expansion/contraction of an image for instance cannot be completely corrected, a combination of the two images by using the area having a large color difference (i.e. first rectangular area) brings about a problem of the combined part of the image standing out too much. Contrarily, a use of area having a small color difference such as the above mentioned background color as the superimpose face will make the combined part less conspicuous if the superimpose face conforms incompletely.

As described so far, the image combine apparatus according to the present invention is capable of not only detecting and correcting a distortion of each input image singularly, but also detecting/correcting a mutual distortion of the input images or detecting an expansion/contraction of the image for the interpolation thereof, without a use of specific configuration, enabling a plurality of images to be combined in a high precision, even it there is a distortion or expansion/contraction.

A processing procedure executed by the above described image combine apparatus is not limited to the one shown by the above described FIG. 2. The following describes a second embodiment by referring to FIG. 4.

FIG. 4 shows a flow chart for describing a processing procedure of the second embodiment executed by the above described image combine apparatus 10.

In FIG. 4, each processing per se in the steps S31, S32, S33 and S34 is approximately the same as the steps S11, S12, S13 and S15, respectively, shown by FIG. 2. Also, each processing per se in the steps S39, S40, S41 and S42 is approximately the same as the steps S18, S19, S20 and S21, respectively, shown by FIG. 2.

The processing of FIG. 4 differ from those of FIG. 2 in the process flow. That is, the processing of FIG. 2 detects a distortion of each input image per se, a mutual overlapping position of images, and a mutual distortion or expansion/contraction of image, by using images with a reduced data size such as a gray scale image, to store in the memory as parameters. Then, performs a processing by using the input images (e.g., color image) finally all at once by using the above mentioned parameters. On the other hand, the processing of FIG. 4 corrects the input images once detecting a distortion of each input image per se. That is, the processing of the step S35 shown by FIG. 4 reads the input images stored in the memory by the processing of the step S31 to correct a distortion in the input image based on the distortion detected in the step S34, followed by storing the distortion-corrected input images in the memory (S36). The processing content itself of the step S35 is approximately the same as the step S17 of FIG. 2, except that the image as the processing object is different. That is, converted images (e.g., gray scale image) are the processing object for the step S17, whereas the input images (e.g., color image) are the processing object for the step S35 as described above.

Then, detects a mutual distortion or expansion/contraction, and an overlapping position, of the images by using the two input images with each distortion being corrected singularly.

First, performs a normalization processing (S37) and color conversion processing (S38) by using the “input images with each distortion being corrected” stored in the memory in the step S36. The processing contents per se for the steps S37 and S38 are approximately the same as the steps S32 and S33, respectively, except for the difference being that the processing object is the “input images with each distortion being corrected.” Subsequently, performs the processing of the steps S39 through S42, the same as the processing of the steps S18 through S21 shown by FIG. 2.

The processing content itself of the last step S43 is approximately the same as that of the step S22 of FIG. 2, except for the difference being that the processing object is the “input images with each distortion being corrected” and a distortion of each image itself is not used as parameter (N.B: there is no need, because the distortion is already corrected).

By the above described processing, the second embodiment, as with the first embodiment, is also capable of detecting and correcting a distortion of input images, or detecting an expansion/contraction for the interpolation thereof, enabling a plurality of images to be combined in a high precision, even if there is a distortion or expansion/contraction.

Lastly, in the following, let the detail be described of the method noted in the above described previous application, an example of which is already described in reference to FIGS. 5 through 10, and therefore the other methods thereof (i.e., part 1 and part 2) in detail.

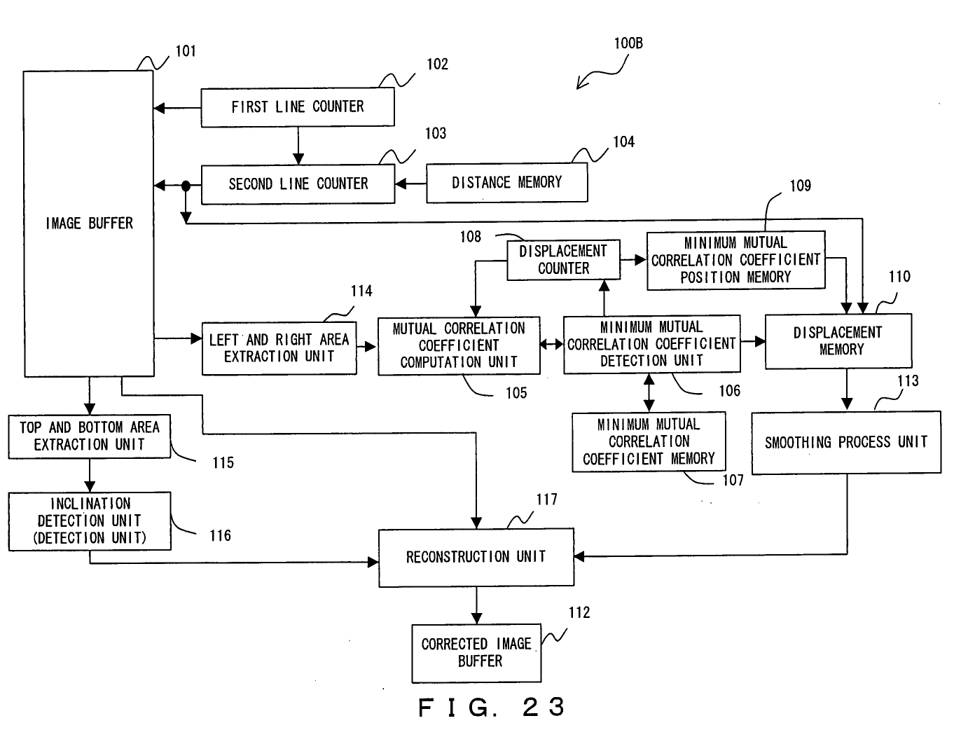

FIG. 23 is a block diagram showing a configuration of an image processing apparatus according to the other method (part 1) presented by the previous application.

In the image processing apparatus 100B shown by FIG. 23, the same component numbers are given for approximately the same configuration as the image processing apparatus 100 shown by FIG. 5, with the detailed description being omitted. Furthermore, the image processing apparatus 100B comprises a left and right area extraction unit 114, a top and bottom area extraction unit 115 and an inclination detection unit 116, and in addition, comprises a reconstruction unit 117, replacing the linear interpolation unit 111.

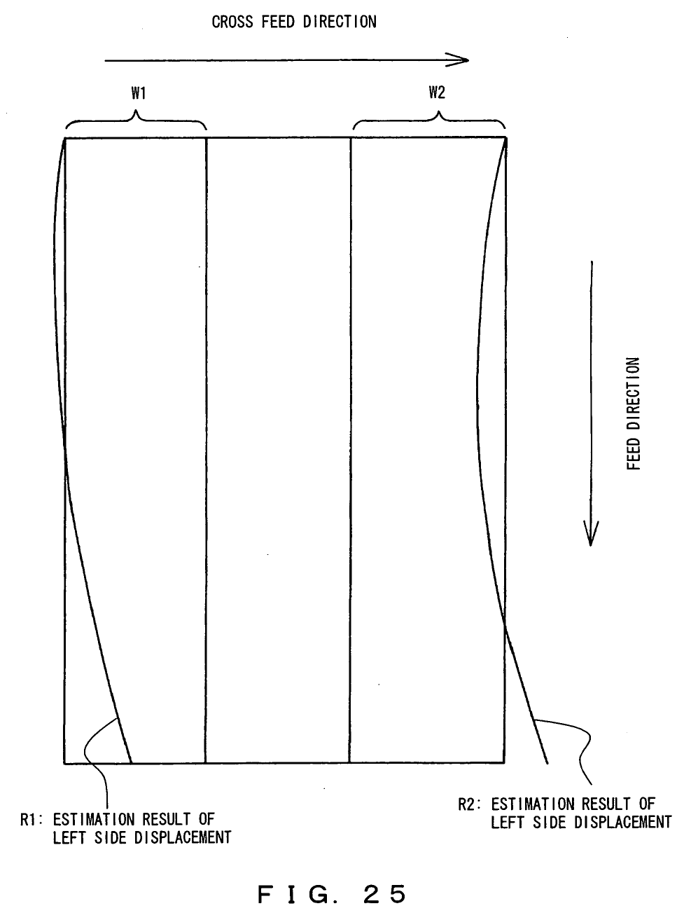

The left and right area extraction unit 114 extracts image data for the left and right areas thereof from the image buffer 101 so as to estimate the displacement amounts for the left and right sides, respectively, as described later with reference to FIG. 25, and specifically, divides the entire image data into three parts in the cross feed direction as shown by FIG. 25 to extract the left area W1 and the right area W2.

The left and right area extraction unit 114, together with the above described first line counter 102, second line counter 103, distance memory 104, mutual correlation coefficient computation unit 105, minimum mutual correlation coefficient detection unit 106, minimum mutual correlation coefficient memory 107, displacement counter 108 and minimum mutual correlation coefficient position memory 109, provides the function of estimating displacement amounts in the cross feed direction for the left and right sides of image data, respectively, based on a mutual correlation between partial data constituting a plurality of rows of line data, that is, based on a mutual correlation between data belonging to the left side area W1 and the right side area W2, respectively. In other words, the displacement estimation method described for FIGS. 5 through 10 is applied to each of the left and right areas W1 and W2 extracted by the left and right area extraction unit 114, and the displacements in the left and right sides of line data are respectively estimated for each line distanced at a suitable interval, d, in the feed direction, to store the estimation results in the displacement memory 110 in this embodiment.

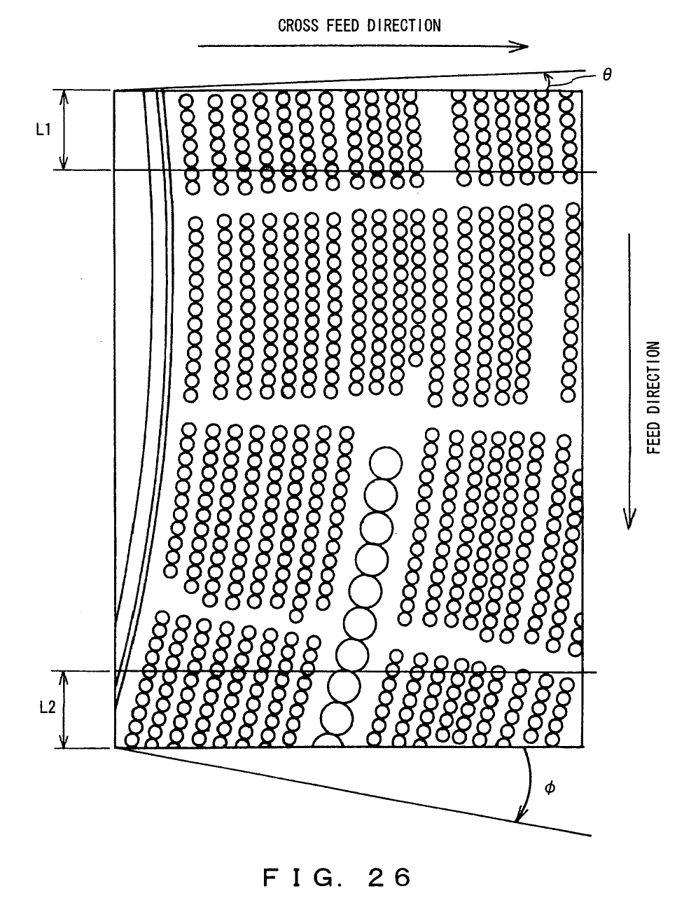

The top and bottom area extraction unit 115 is for extracting the top and bottom areas of image data from the image buffer 101 so as to detect the inclinations of image (i.e., character string actually) in the top and bottom areas of the image data, respectively, as described later while referring to FIG. 26, and, specifically, for extracting a top area L1 and a bottom area L2 both with an appropriate width as shown by FIG. 26.

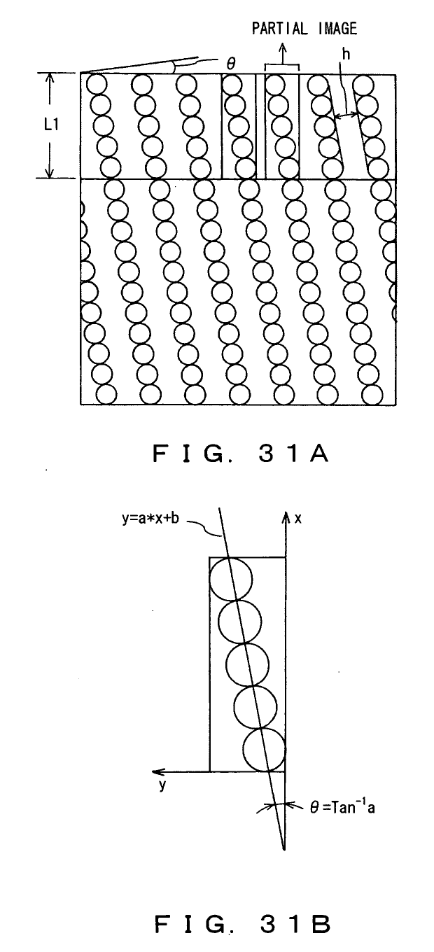

The inclination detection unit (detection unit) 116 detects the respective inclinations of the images in the top and bottom areas thereof based on the top area L1 and the bottom area L2 extracted by the top and bottom area extraction unit 115. In this embodiment, assuming that the image data is a document image, the inclination detection unit 116 detects the respective inclinations of the images on the top and bottom sides based on the inclinations of character string forming the document image by using the technique disclosed by a Japanese patent laid-open application publication No. 11-341259 as described later by referring to FIGS. 26, 31(a) and 31(b).

The reconstruction unit (reconstruction unit) 117 reconstructs the image data stored in the image buffer 101 so as to eliminate the distortion on the image data based on the displacement amounts for the left and right sides estimated as described above and stored in the displacement memory 110 and on the inclination of the top and bottom sides detected by the inclination detection unit 116 as described above, followed by writing the corrected image data in the corrected image buffer 112.

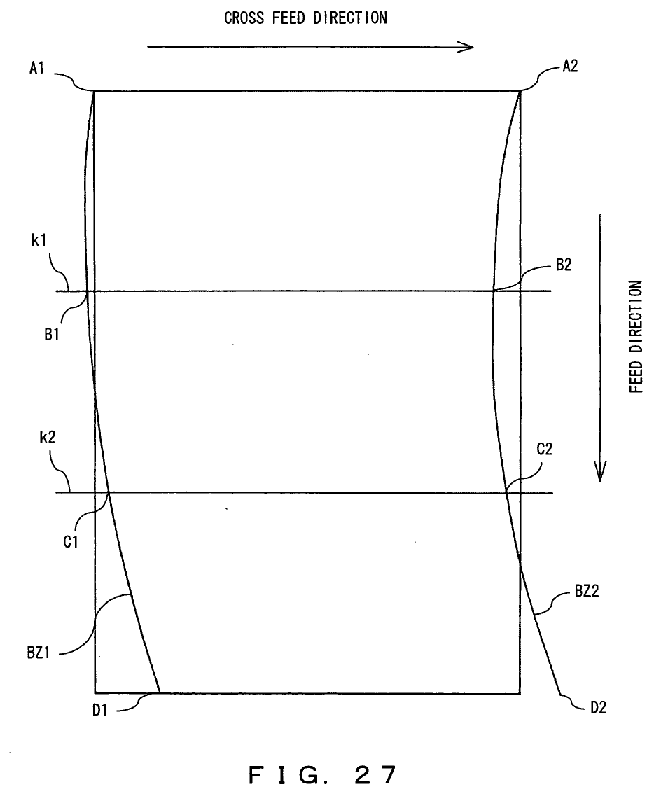

The smoothing process unit 113 applies a smoothing processing for the displacement amounts stored in the displacement memory 110 by using the Bezier curve to output the smoothed displacement amounts to the reconstruction unit 117. And the reconstruction unit 117 is configured for reconfiguring the image data by using a mediation variable, t, of the Bezier curve (i.e., displacement amounts) for the left and right sides acquired by the smoothing process unit 113 as described later by referring to FIGS. 27 through 39.

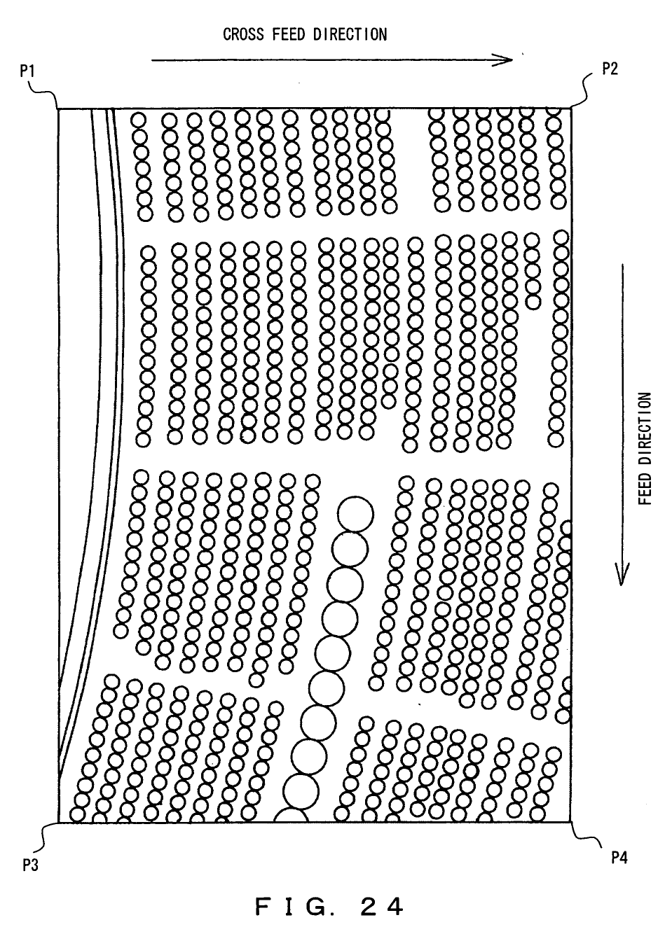

Next, an operation of the image processing apparatus 100B according to the present embodiment will be described with reference to FIGS. 24 through 31(b). Note that each of the FIGS. 24 through 30 is for describing the image processing method according to the present embodiment, while each of FIGS. 31A and 31B is for describing the detection method for image inclination according to the present embodiment.

To begin with, here the description is about the image processing apparatus 100B performing a correction processing for image data (original image) picked up by a handheld image scanner and stored in the image buffer 101, which is a document image (a vertical writing) as shown by FIG. 24 for instance, indicating an image data with a two-dimensional distortion (i.e., a rectangular image with the apexes P1 through P4). The two-dimensional distortion is caused by the image scanner slipping against the scanning object document during the scanning operation for instance, resulting in the scanning area of the image scanner 10 becoming a fan shaped. Note that FIGS. 24, 26, 30, 31(a) and (b) show a character by “o”, while FIGS. 25, 27 and 28 omit showing a character by “o” for an easy viewing of description.

First, estimates displacement amounts in the left and right sides of image data, that is, applies the displacement estimation described in FIGS. 5 through 10 to each of the left and right areas W1 and W2 of the image data, respectively, extracted by the left and right area extraction unit 114 as shown by FIG. 25. By this, displacement amounts in the left and right sides, respectively, of the line data are estimated for each line distanced by a suitable interval, d, in the feed direction, respectively, and the estimation result R1 and R2 will be stored in the displacement memory 110.

Note that the displacement amounts for the left and right sides stored in the displacement memory 110 are the one between a pair of lines distanced from each other by a certain interval, which is either one of “−1”, “0” or “1” as described above. The displacement estimation results R1 and R2 in FIG. 25 are respectively obtained by figuring out displacement amounts relative to the original image (i.e., a movement of image scanner) by sequentially integrating (add up) the displacement amounts in the cross feed direction for the left and right sides, respectively, and making the results corresponding to the feed direction.

Next, the top and bottom area extraction unit 115 and the inclination detection unit 116 detect inclinations of the image in the top and bottom areas of the image data. That is, the inclination detection unit 116 detects the inclination angles, θ and φ, of the top and bottom areas of the image, respectively, by using the image data (i.e., character string image) within the top and bottom areas L1 and L2, respectively, extracted by the top and bottom area extraction unit 115, as shown by FIG. 26. The inclination angle θ corresponds to the angle of the image scanner lining up relative to the character string at the start of scanning operation, while the inclination angle φ corresponds to the angle of the image scanner lining up relative to the character string at the end of scanning operation.

Let it describe here a method which the inclination detection unit 116 employs for detecting the inclination angle θ in the top area with reference to FIGS. 31A and 31B. The inclination detection method is disclosed by the Japanese patent laid-open application publication No. 11-341259.

That is, the inclination detection unit 116 extracts one row of character string (i.e., a continuous five characters in the example of FIG. 31A) from the top area L1 as a partial image as shown by FIG. 31A. The partial image is cut out as a rectangle with the sides circumscribing the above mentioned character string and being parallel to the cross feed and feed directions of the image. Then, sets the x- and y-axes for the cutout partial image as shown by FIG. 31B, approximates the coordinates of black pixels forming the characters within the partial image by a straight line, i.e., the straight line, y=a*x+b shown by FIG. 31B. The inclination of the straight line “a” can be calculated by the following equation (2) as an inclination of a regression line for the coordinates of black pixels:
a=(NΣxiyi−ΣxiΣyi)/(NΣxi²−(Σxi)²) (2);
where “E” means a grand total of i=0˜N−1; N is the number of black pixels within the partial image; xi and yi are x- and y-coordinates of the i-th black pixel. The following equation (3) calculates the upper inclination angle θ based on the inclination “a” gained by the above equation (2). The calculation is the same as above described for the inclination angle φ in the bottom area.
   θ=Tan⁻¹ a (3)

Thus calculates the inclination angles θ and φ of the character string relative to the cross feed direction, or the feed direction, as the inclination of image, that is, the angles of image scanner lining up relative to the character string.

Meanwhile, if only one partial image is used for calculating the angle of inclination, it may become impossible to figure out an accurate inclination angle as a result of influences such as an error in linear approximation. To avoid this, it is desirable to extract a plurality of partial images from the top and bottom areas L1 and L2, respectively, in calculating the inclination angles for the respective partial images by the above described equations (2) and (3), in which case valid angles will be selected from among the calculated plurality thereof to determine the average of the selected valid angles as the final inclination angles θ and φ.

Then, the smoothing process unit 113 applies a smoothing processing using Bezier curve to the estimation results, R1 and R2, of the displacement amounts acquired as shown by FIG. 25 to gain the Bezier curves BZ1 and BZ2 as shown by FIG. 27, by which the movements of both ends of the image scanner (i.e., line sensor) is respectively approximated.

A Bezier curve is generally expressed by the following equation (4):
r(t)=A*(1−t)³+3*B*t*(1−t) ²+3*C*t²*(1−t)+D*t³ (4);
where A, B, C and D are vector constants; and t is a mediation variable. Meanwhile, in FIG. 27, the vector constants A, B, C and D of the Bezier curve BZ1 approximating the estimation result R1 for the left side are indicated by A1, B1, C1 and D1, while the vector constants A, B, C and D of the Bezier curve BZ2 approximating the estimation result for the right side R2 are indicated by A2, B2, C2 and D2.

Here, the vector constants A1 and A2 are given as the vectors indicating the two apexes P1 and P2 of the image data (refer to FIG. 24), respectively. And the vector D (i.e., D1 and D2) are given as the vectors indicating the bottom points of the estimation results, R1 and R2, respectively, acquired as shown by FIG. 25.

Two of control points B (i.e., B1 and B2) and C (i.e., C1 and C2) must be established between the points A and D, respectively, in order to figure out a Bezier curve. Let it define h1 as the estimation result for displacement amount at the position k1 which is at one third (⅓) of the image length in the feed direction, and h2 as the estimation result for displacement amount at the position k2 which is at two thirds (⅔) of the image length in the feed direction. Hence the definition of Bezier curve gives the following equations (5) and (6) for the control points B and C:
B=(18.0*h1−9.0*h2−5.0*A+2.0*D)/2.0 (5)
C=(18.0*h2−9.0*h1−5.0*D+2.0*A)/2.0 (6)

By establishing the vector constants A, B, C and D as described above, the Bezier curves BZ1 and BZ2 approximating the estimation results R1 and R2, respectively, are given by the above equation (4) for smoothing the displacement amounts in the left and right sides and, at the same time, enabling the movement of the image scanner at either end to be estimated.

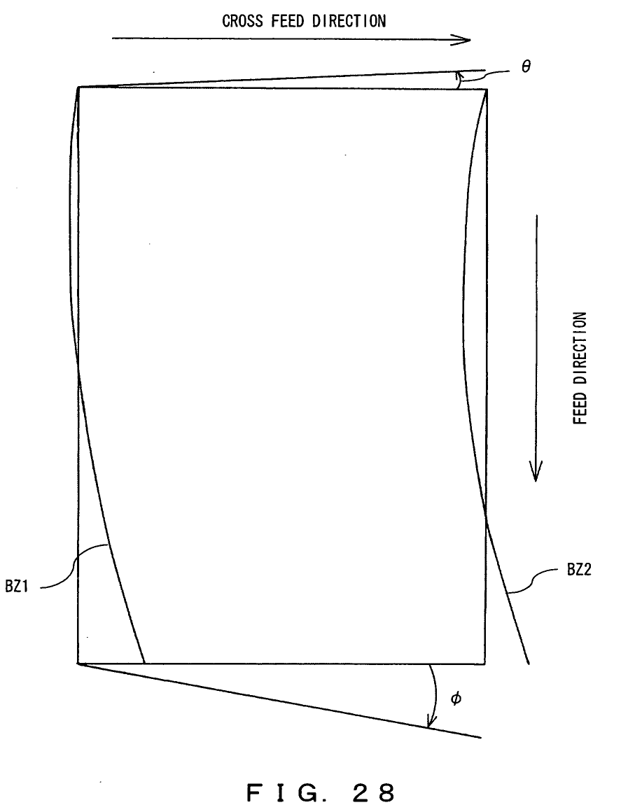

The above described processings gain the Bezier curves BZ1 and BZ2 indicating the displacement amounts in the left and right sides of the image data and the inclination angles, θ and φ, of image in the top and bottom areas of the image data as shown by FIG. 28.

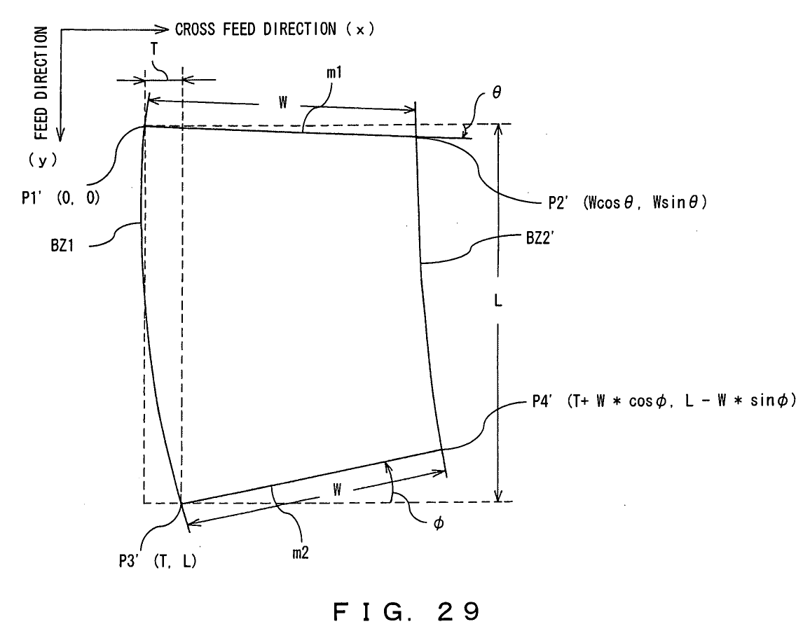

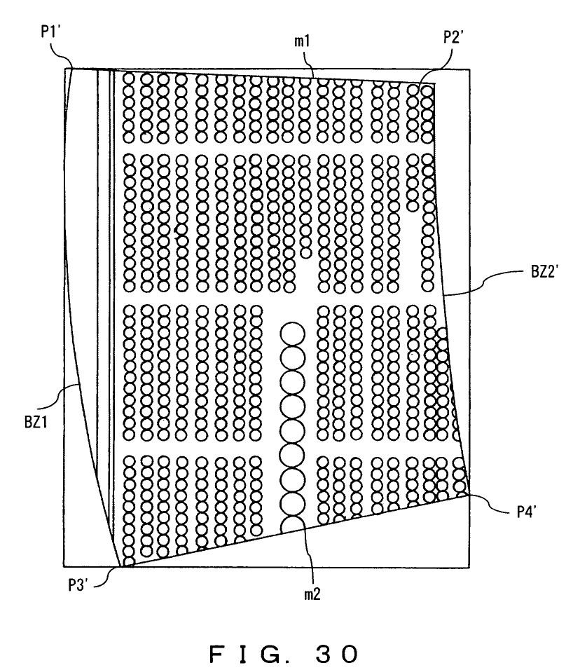

Then, the reconstruction unit 117 reconfigures the form of area (refer to FIG. 29) actually scanned by the scanner based on these Bezier curves BZ1 and BZ2 as well as the inclination angles θ and φ, and reallocate the image data shown by FIG. 24 in the reconfigured area to store the final reconfigured image data (i.e., corrected image data) as shown by FIG. 30 in the corrected image buffer 112.

The reconstruction for the form of area actually scanned by the image scanner is as shown by FIG. 29 based on the Bezier curves BZ1 and BZ2 as well as the angles θ and φ. Here, the pickup width and the pickup length (i.e., image length in the feed direction) are defined as W and L, respectively. The pickup width W is physically constant and therefore a fixed value, while the pickup length L is determined by the number of lines picked up by the image scanner.

The position of image scanner at the scanning start is given as the straight line m1 by the inclination angle θ in the top side as shown by FIG. 29. The length of the straight line m1 is equal to the fixed pickup width W. With the left end of the straight line m1 overlapping perfectly with the top end of the left Bezier curve BZ1, overlays the straight line m1 on top of the Bezier curve BZ1. And, with the bottom end of the Bezier curve BZ1 overlapping perfectly with the left end of a straight line m2 having the inclination angle φ relative to the cross feed direction and the length W, overlays the Bezier curve BZ1 with the straight line m2 which is the position of the image scanner 10 at the end of the scanning. Finally, overlays a Bezier curve BZ2′ between the right ends of the straight lines m1 and m2 which is the Bezier curve BZ2 reduced corresponding to the distance between the ends of the aforementioned two lines m1 and m2. This is how to reconstruct the area actually scanned by an image scanner.

In the example shown by FIG. 29, the scan area is reconstructed with the left side as reference since the moving distance (i.e., displacement amount) is greater on the left side as compared to the right side. And, setting a coordination system defining the x- and y-axes as the cross feed and feed directions, respectively, and the origin (0,0) as the top left apex P1′ of the reconstruction area and assuming the displacement amount T between the top and bottom ends of the left Bezier curve BZ1, then the coordinates of the other three apexes P2′, P3′ and P4′ are expressed by (W*cos θ, W*sin θ), (T, L) and (T+W*cos φ, L−W*sin φ), respectively.

Then, the image data shown by FIG. 24 are reconstructed within the reconstructed area as shown by FIG. 29 to reconstruct the image as shown by FIG. 30. The four apexes P1, P2, P3 and P4 of the image data shown by FIG. 24 naturally correspond to the four apexes P1′, P2′, P3′ and P4′, respectively.

In the processing, the construction of the image data uses the mediation variable, t, of the Bezier curves BZ1 and BZ2′ for the left and right sides. The Bezier curves BZ1 and BZ2′ are functions using the mediation variable, t, which equal to the vector A (i.e., A1 and A2) when t=0; to the vector D (i.e., D1 and D2) when t=1.

Then, reallocates pixels by using the mediation variable dividing the range 0˜1 by the number of lines NL corresponding to the image length L in the feed direction. That is, when reallocating the j-th line of FIG. 24 within the reconstructed area shown by FIG. 29, the two points gained by taking the mediation variable t as j/NL and substituting the j/NL for the two Bezier curves BZ1 and BZ2′, respectively, become the positions of both ends of the j-th line after reconstruction. Then reallocate the pixels of the j-th line on the straight line connecting the acquired two points.

There is a possibility of missing a pixel in the image obtained by the above described reconstruction. If there is missing pixel data, calculates the average of the pixels in the surrounding area of the missing part to use it for the pixel data therefor.

The above described processing reconstructs the image data stored in the image buffer 101 to the one as shown by FIG. 30 and corrects the distortion of the image data for writing the corrected image data in the corrected image buffer 112.

Note that, while the control points are positioned at one third and two thirds of the image length in the feed direction from the top edge in the present embodiment, positions of the control points are not limited as such.

As described, the image processing apparatus 100B by the other method noted by the previous application is capable of correcting a two-dimensional distortion of image data by using the picked up image data only, without using a two-dimensional sensor. Even if a two-dimensional slipping occurs during a scanning operation by using the handheld image scanner 10 as shown by FIG. 45B, resulting in a distortion of image data as shown by FIG. 24, it is possible to eliminate the distortion to gain a high quality image data, free of distortion. Therefore it is possible to obtain a high quality image data, free of distortion, without ushering in a manufacturing cost increase.

Also in the processing, the line data is sequentially extracted in a suitable interval, d, (e.g., 5 to 20 lines) in the feed direction from the left and right sides image data areas, and the misalignment amounts for the left and right sides are respectively estimated based on a mutual correlation between the extracted line data as with the example described in association with FIG. 5 and other figures, therefore it is possible to perform the image correction processing by a reduced computing load for estimating the displacement amounts in the cross feed direction, while improving the computation accuracy of the displacement amounts in the cross feed direction.

In the meantime, a reconstruction of image following a smoothing processing for the displacement amounts in the cross feed direction makes it possible to eliminate appropriately a precipitous displacement in the image data caused by a precipitous movement of an image scanner so as to obtain a high quality image data. A use of the Bezier curve (refer to the above described equation (4)) for such a smoothing processing enables the image data to be reconstructed easily by using the mediation variable t of the Bezier curve.

The present embodiment further makes it possible to figure out easily the inclination angles, θ and φ, of images on the top, bottom, left and right sides of the image data based on the inclination of character string forming a document image as image data.

Next, the other (part 2) of the method noted in the previous application will be described in the following.

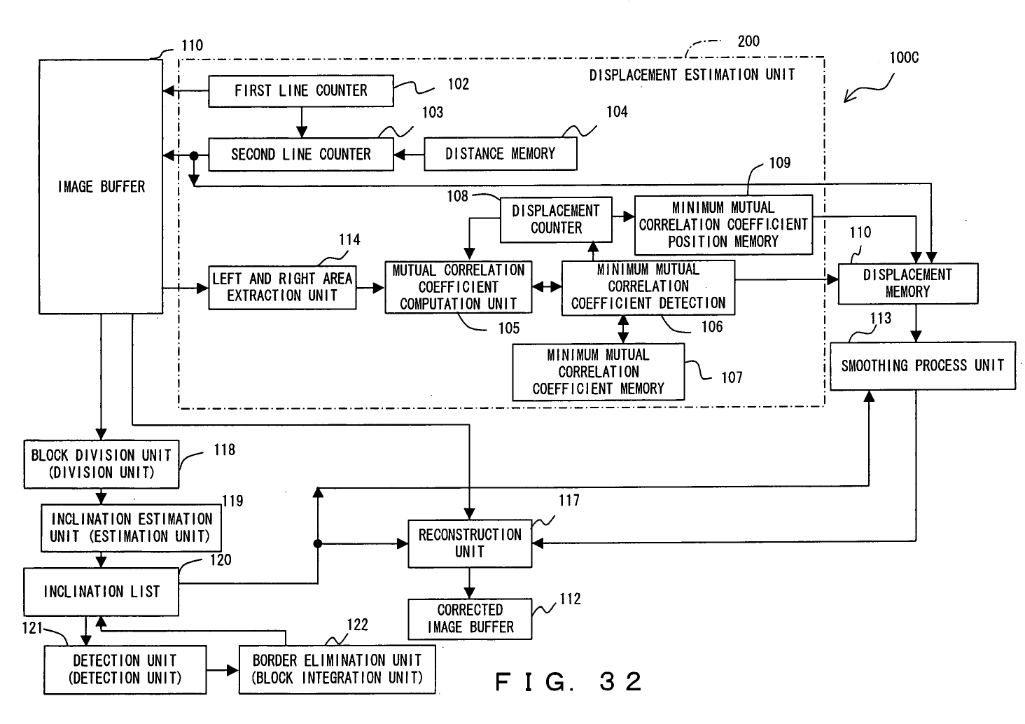

FIG. 32 is a block diagram showing a configuration of an image processing apparatus according to the other method (part 2) presented by the previous application, in which the image processing apparatus 100C, when comparing with the image processing apparatus 100B of the above described other method (part 1), comprises a block division unit 118, an inclination estimation unit 119, an inclination list 120, a detection unit 121 and a border elimination unit 122; replacing the top and bottom area extraction unit 115 and the inclination detection unit 116. Note that the component numbers which are already described above are the same or a similar so that the description thereof will be omitted here.

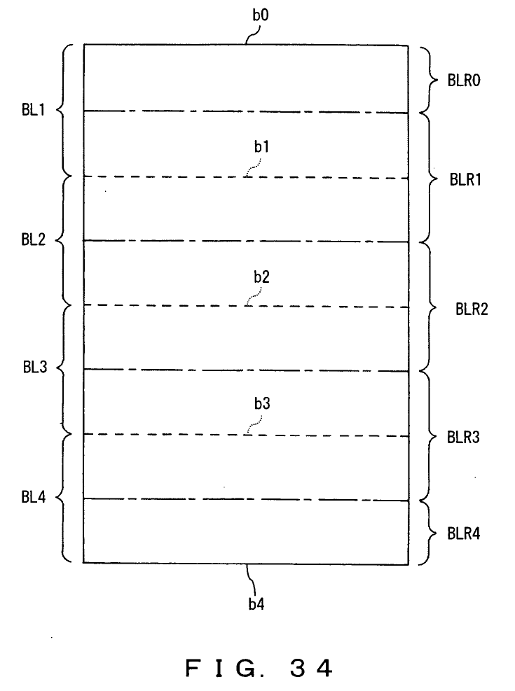

Here, the block division unit (division unit) 118 divides image data stored in the image buffer 101 into a plurality of blocks (e.g., signs BL1 through BL4 shown by FIG. 34) in the feed direction (i.e., top to bottom direction) according to a predetermined division number (i.e., 4 or 5 in the present example).

The inclination estimation unit (inclination estimation unit) 119 estimates the inclination of image on the top and bottom sides of each block which have been divided by the block division unit 118.

The inclination estimation unit 119 estimates the inclination of the image on the border between the two neighboring blocks (e.g., refer to the signs b1 through b3 in FIG. 34) among a plurality thereof (e.g., refer to the signs BL1 through BL4 in FIG. 34) as the inclination of the border based on image data existing in the area straddling the border (e.g., refer to the signs BLR1 through BLR3) and stores in the inclination list 120. Thus estimated inclination of the border (border bi; where i=1, 2, 3) is adopted as a result of estimating image inclination in the lower part of the upper block (i.e., block BLi) of the two block and the upper part of the lower block (i.e., block BLi+1).

The inclination estimation unit 119 also estimates an inclination of the image in the upper part of the top block (refer to the sign BL1 in FIG. 34) as the inclination of the top border, that is, the inclination of the upper border of the top block (refer to the sign b0 in FIG. 34) based on the image data existing in the upper area of the image data (e.g., refer to the sign BLR0 in FIG. 34); and an inclination of the image in the lower area of the bottom block (refer to the sign BLR4) as the inclination of the bottom border, that is, as the inclination of the bottom border of the bottom block (refer to the sign b4 in FIG. 34) based on the image data existing in the lower area (e.g., refer to the sign BLR4 in FIG. 34).

Note that the aforementioned other method (part 2), as in the above described other method (part 1), assuming that the image data is a document image, the inclination estimation unit 119 detects an image inclination on the upper and lower sides of each block based on the inclination of character string forming the document image, by using the technique disclosed by the Japanese patent laid-open application publication No. 11-341259. The inclination estimation method employed by the inclination-estimation unit 119 will be described later by referring to FIG. 34.

The inclination list 120 stores the inclination of each border, estimated by the inclination estimation unit 119 as described above, in relation with identification information for specifying the respective borders.

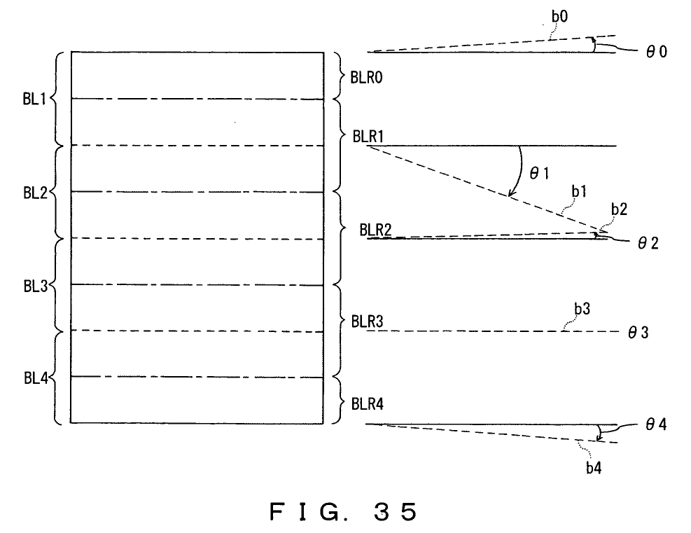

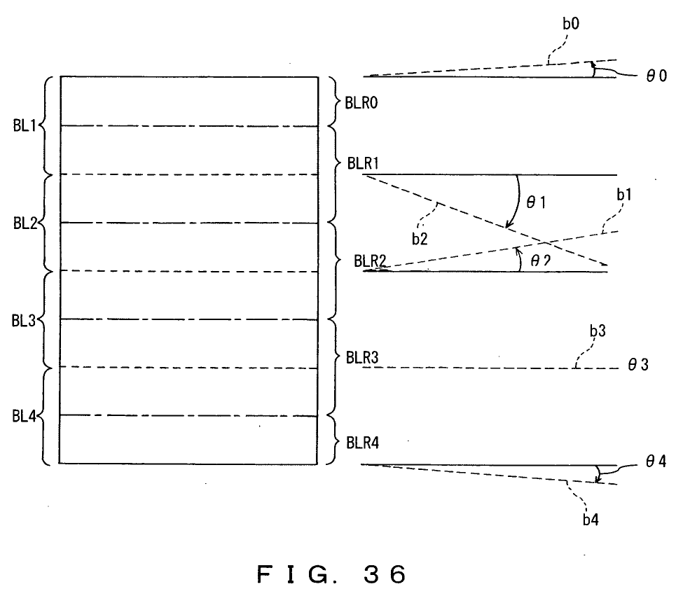

The detection unit (detection unit) 121 detects a border whose angle relative to the neighboring border is equal to or greater than a predetermined number, or a border crossing with another one in the image area, as a border whose inclination angle is wrongly estimated based on the plurality of inclinations of borders which are stored in the inclination list 120. Example of border whose inclination angle is wrongly estimated will be described later by referring to FIGS. 35 and 36.

The border elimination unit (block integration unit) 122 integrates the two blocks sandwiching the border detected by the detection unit 121 into one block. In the present example, the configuration is such that the border elimination unit 122 deletes/eliminates the inclination corresponding to the border detected by the detection unit 121 (i.e., the border whose inclination angle is wrongly estimated) from the inclination list 120, thereby integrating the two blocks sandwiching the border into one, and that a displacement estimation unit 200 and a reconstruction unit 117 perform an estimation processing and reconstruction processing, respectively, based on the inclination list 120 with a wrong inclination being eliminated, that is, base on the integrated block, as described above.

The displacement estimation unit 200 comprises the above described first line counter 102, second line counter 103, distance memory 104, mutual correlation coefficient computation unit 105, minimum mutual correlation coefficient detection unit 106, minimum mutual correlation coefficient memory 107, displacement counter 108, minimum mutual correlation coefficient position memory 109, and left and right area extraction unit 114. While the displacement estimation unit 200 in this example is configured the same as the above described other method (part 1), with the same component numbers and functions, this example is configured to estimated is placement amounts in the cross feed direction for the left and right sides of each block BLi divided and obtained by the block division unit 118 based on a mutual correlation between partial data forming a line data within each block BLi, that is, a mutual correlation between data respectively belonging to the left side area W1 and the right side area W2.

That is, in the displacement estimation unit 200 of this example, the displacement amount estimation method described in reference to FIG. 5, et cetera, is applied to each of the left and right areas W1 and W2, for each block BLi, extracted by the left and right area extraction unit 114, the displacement amounts of line data of the left and right sides are estimated for a series of lines distanced in the interval, d, (e.g., 5 to 20 lines) in the feed direction so as to store the estimation result in the displacement memory 110.

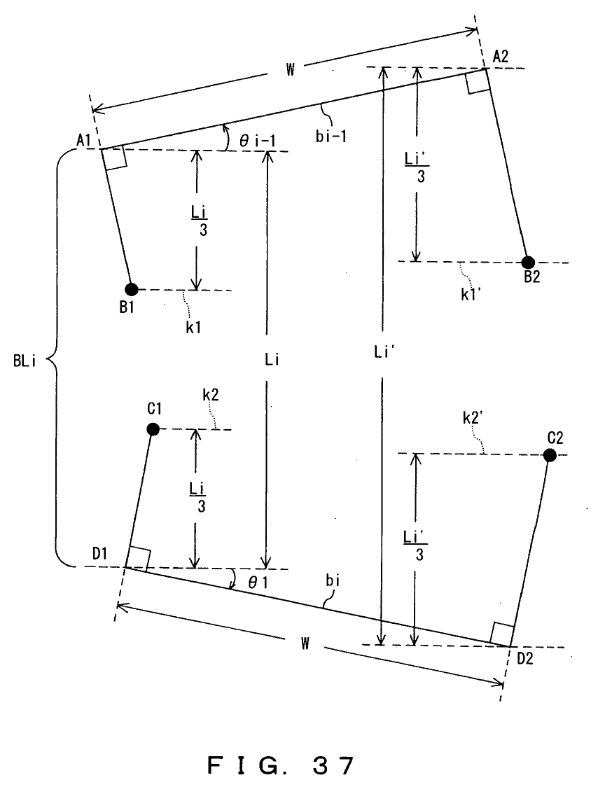

The smoothing process unit 113 of this example, as in the other method (part 1), is configured to apply a smoothing processing by using a Bezier curve to the displacement amounts stored in the displacement memory 110 and outputs the smoothed displacement amounts to the reconstruction unit 117, except that in the smoothing process unit 113 of this example, unlike in the another method (part 1), the control points for figuring out the Bezier curves are established in consideration of the inclination on the top and bottom sides which have been estimated by the inclination estimation unit 119 and stored in the inclination list 120 for each block BLi as described later in reference to FIG. 37.

And the reconstruction unit 117, as in the other method (part 1), is configured to reconstruct the image data by using the mediation variables, t, of the Bezier curves (i.e., displacement amounts) for the left and right sides gained by the smoothing process unit 113, except that the smoothing process unit 113 and the reconstruction unit 117 in this example are configured to perform the smoothing and reconstruction processing for each block BLi.

And the reconstruction unit 117 reconstructs the image data for each block BLi stored in the image buffer 101 so as to eliminate the distortion of image data within each block BLi based on the displacement amounts on the left and right sides (i.e., the Bezier curve obtained by the smoothing process unit 113, actually) which has been estimated by the displacement estimation unit 200 and stored in the displacement memory 110, and the inclinations in the top and bottom parts which have been estimated by the inclination estimation unit 119, followed by storing the corrected image data within each BLi in the corrected image buffer 112.

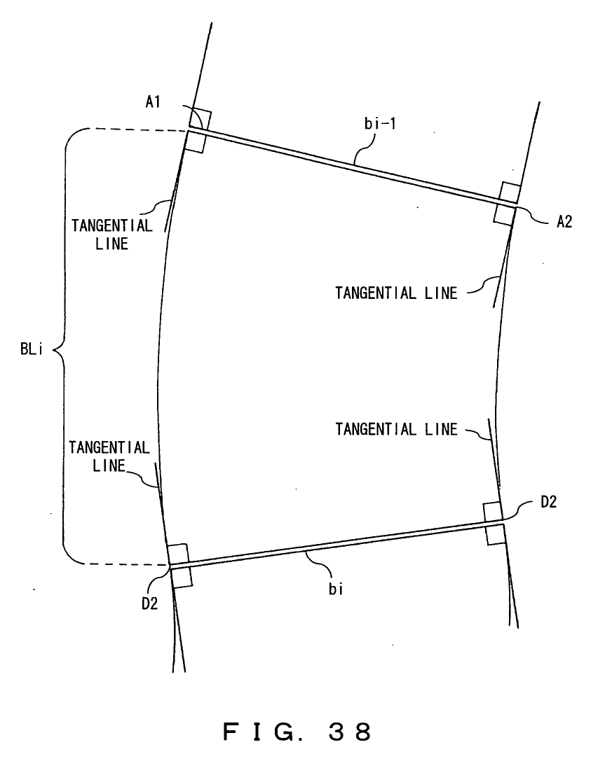

In the processing, the reconstruction unit 117 reconstructs the image data within each block BLi so as to make the tangential lines of image areas in the feed direction at the left and right edges of the top and bottom ends, respectively, cross with the inclinations of the top and bottom parts being estimated by the inclination estimation unit 119 at the right angle for each block BLi as describe later by referring to FIG. 38.

As such, the displacement estimation unit 200, the smoothing process unit 113 and reconstruction unit 117 perform the same processing for each block BLi as the estimation unit, smoothing process unit 113 and reconstruction unit 117, respectively, of the above described other method (part 1).

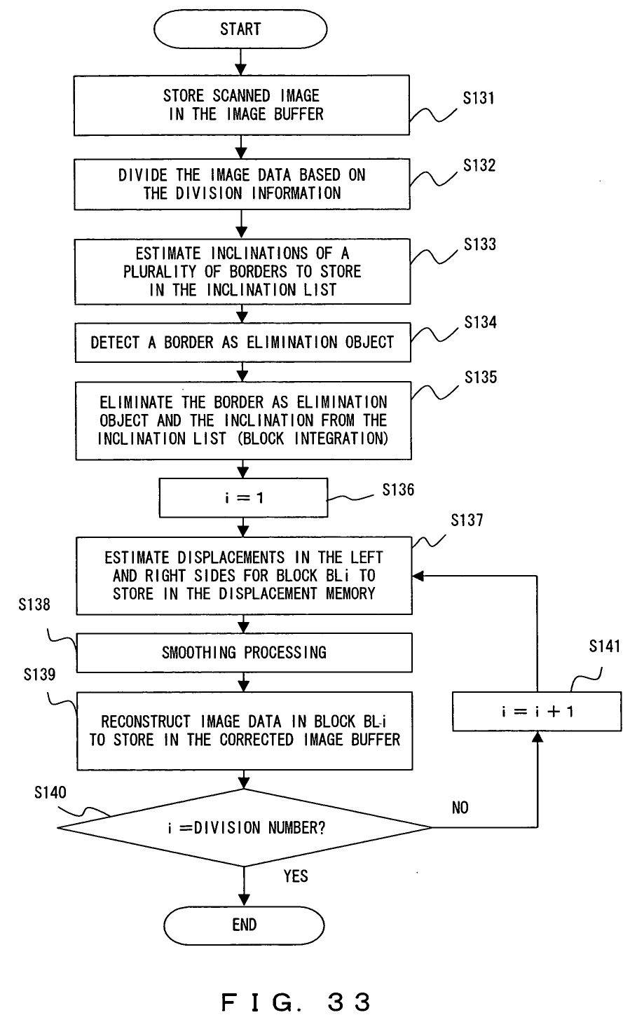

Next, an operation of the image processing apparatus 100C will be described while referring to FIGS. 33 through 41.

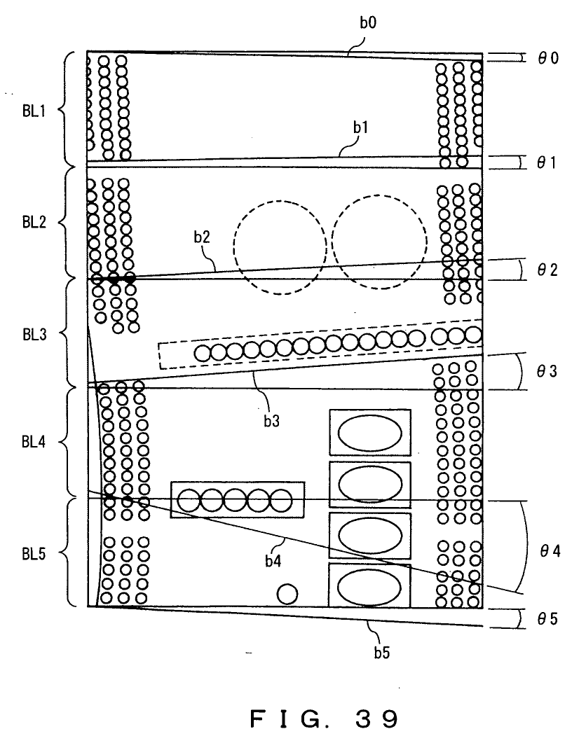

FIG. 33 is a flow chart for describing an image processing method performed by the image processing apparatus 100C; FIG. 34 describes a method for estimating an image inclination (border inclination) on the top and bottom sides of a block; FIGS. 35 and 36 each describes an example of a border whose inclination is wrongly estimated; FIG. 37 describes an example selection of a control point for a Bezier curve; FIG. 38 describes a connection state (at the left and right edges) between blocks after the reconstruction; and FIGS. 39 through 41 respectively describe an image processing method according to the present example.

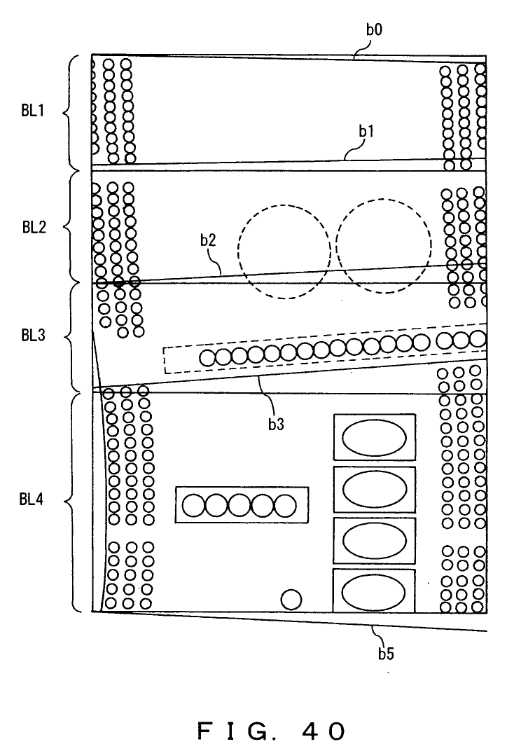

In the present example, the description is about the image processing apparatus 100C performing a correction processing for a document image picked up by a handheld image scanner and stored in the image buffer 101 whose image data (i.e., original image) is a document image (i.e., a vertically written image of a Japanese newspaper) as exemplified by FIGS. 39 and 40. The present example is capable of correcting a document image distorted in two dimensions as shown by FIGS. 39 and 40. The two-dimensional distortion shown here is caused by an image scanner slipping against the scanning object document, snaking its way, during the scanning operation for instance. Note that the FIGS. 39 through 41 show a character by a “o”; and only show three lines (N.B: these are called lines herein because the articles are written vertically) of small characters forming a newspaper article, and not a headline, each for the left and right sides of the image, omitting the small characters “o” in between.

Let the image processing procedure of the fourth embodiment be described in accordance with the flow chart (steps S131 through S141) shown by FIG. 33.

First, a certain document image is picked up by a handheld image scanner and the picked up image data is stored in the image buffer 101 (S131). Let it be assumed that the image scanner snaked its way during the scanning operation by the operator, resulting in picking up image data (i.e., document image) as exemplified by FIG. 39.

Then, the block division unit 118 divides the image data stored in the image buffer 101 into a plurality of blocks in the feed direction (i.e., the up to down directions) based on a predetermined division information (i.e., number of divisions) (S132). FIG. 34 exemplifies a case of four as the number of divisions so as to divide the image data into four equal blocks BL1 through BL4, while FIG. 39 exemplifies a case of five as the number of divisions so as to divide the image data into five equal blocks BL1 through BL5, in the feed direction for both of the above.

Then, the inclination estimation unit 119 estimates the inclination of image on the top and bottom sides of each block BLi (where i=1 through 4, or 1 through 5) divided and obtained by the block division unit 118 to store in the inclination list 120 (S133). In the processing, the inclinations of the image on the top and bottom sides of each block BLi is detected by the inclination of character string forming the document image by using the technique disclosed by the Japanese patent laid-open application publication No. 11-341259, that is, the above described method in reference to FIGS. 26, 31(a) and 31(b).

To be specific about it, the inclination of image on the upper side of the top block BL1 is estimated as the inclination, θ0, of the upper most border, b0, based on the inclination of a character string (i.e., image data) existing in the top half area BLR0 of the block BL1 as shown by FIGS. 34 through 36 and 39.

And the inclination of image on the lower side of the top block BL1 is estimated as the inclination, θ1, of the border, b1, between the blocks BL1 and BL2 based on the inclination of a character string existing in the area BLR1 which is made up of the lower half of the block BL1 and the upper half of the block BL2.

Thus estimated inclination, θ1, of the border, b1, will also be used as the inclination of image on the upper side of the block BL2. Likewise, the inclinations of images on the upper and lower sides of each block BL2, BL3, BL4 and BL5 are estimated as the inclinations θ2 through θ5 of each border b2, b3, b4 and b5, respectively.

Meanwhile, the inclination of image on the lower side of the bottom block BL4, or BL5, is estimated as the inclination θ4, or θ5, of the bottom border, b4, or b5, based on the inclination of a character string (i.e., image data) existing in the lower half area BLR4, or BLR5, of the block BL4, or BL5, respectively.

Then, the detection unit 121 detects a border, whose inclination is wrongly estimated, as an elimination object border based on the inclinations θ0 through θ5 of the border b0 through b5, respectively, stored in the inclination list 120 (S134). The elimination object border is a border whose angle relative to the neighboring border is equal to or greater than a predetermined angle, or one which crosses with another border within an image area.

In the example shown by FIG. 35, the judgment is that the angle of the border b1 relative to the neighboring border b0 is equal to or greater than the predetermined angle, and thus the border b1 becomes an elimination object. Also, in the example shown by FIG. 39, the judgment is that the angle of the border b4 relative to the neighboring border b3 is equal to or greater than the predetermined angle, and thus the border b4 becomes an elimination object. Furthermore, in the example shown by FIG. 36, the judgment is that the border b1 crosses with the other border b2 within the image area, thus the border b1 becomes an elimination object.

Once the detection unit 121 detects an elimination object border as described above, the border elimination unit 122 integrates the two blocks sandwiching the elimination object border into one block, in which the border elimination unit 122 eliminates/discards the information (e.g., identification information, inclination) about the elimination object border from the inclination list 120, thereby integrating the two blocks sandwiching the elimination object border into one block (S135).

In the examples shown by FIGS. 35 and 36, the blocks BL1 and BL2 are integrated by eliminating/discarding the information about the border b1 from the inclination list 120, and the integrated block is treated as the block BL1. And in the example shown by FIGS. 39 and 40, eliminating/discarding the information about the border b4 from the inclination list 120 integrates the blocks BL4 and BL5 so as to treat the integrated block as the block BL4.

Then, setting the parameter, i, at the initial value “1” (S136), the displacement estimation unit 200 estimates the displacement amounts on the left and right sides for the blocks BLi (S137), in which the displacement estimation method already described in reference to FIG. 5, et cetera, is applied to each of the left and right areas W1 and W2 of the blocks BLi being extracted by the left and right area extraction unit 114. By this, the displacement amounts on the left and right sides of the line data forming the blocks BLi are respectively estimated for each line distanced by a suitable interval, d, in the feed direction and the estimation results R1 and R2 will be stored in the displacement memory 110.

Note that the displacement amounts for the left and right sides stored in the displacement memory 110 are displacements between a line pair apart from each other by a certain distance whose value is one of “−1”, “0” or “1” also in the present example, as described above. The estimation results R1 and R2 are a result of figuring out the displacement amounts relative to the original image (i.e., the movement of image scanner) by sequentially integrating (add up) the displacement amounts in the cross feed direction for the left and right sides, respectively, being stored in the displacement memory 110 and of relating the result to the positions in the feed direction.

Then, the smoothing process unit 113 applies a smoothing processing by using the Bezier curves to the displacement estimation results R1 and R2 obtained for the block BLi as described above, thereby approximating the movements of both ends of the image scanner (i.e., line sensor) by the Bezier curves (S138).

A Bezier curve is expressed commonly by the above noted equation (4).

Let it be defined here that the vector constants A, B, C and D of the Bezier curve BZ1 approximating the estimation result R1 for the left side of the block BLi are denoted by A1, B1, C1 and D1, respectively, while the vector constants A, B, C and D of the Bezier curve BZ2 approximating the estimation result R2 for the right side of the block BLi are denoted by A2, B2, C2 and D2. And the vector constants A1 and A2 are respectively given as the vectors indicating the two top apexes of the block BLi, while the vector constants D1 and D2 are respectively given as the vectors indicating the two bottom apexes (i.e., the bottom points of the estimation results R1 and R2) of the block BLi as shown by FIG. 37.

Then, two control points B (B1 and B2) and C (C1 and C2) need to be established between A (A1 and A2) and D (D1 and D2) for figuring out the Bezier curves. In the smoothing processing according to the present example, the control points B (B1 and B2) and C (C1 and C2) are established in consideration of the inclinations on the upper and lower sides estimated by the inclination estimation unit 119, that is, the inclinations θi-1 and θi of the borders bi-1 and bi, respectively, as shown by FIG. 37.

In FIG. 37, let it define that Li is the distance between the left apexes A1 and D1 of the block BLi in the feed direction; k1 is a feed direction line being distanced from the apex A1 by Li divided by 3 (ala “Li/3” hereinafter); and k2 is a feed direction line being distanced from the apex A1 by 2*Li/3. Likewise, Li′ is the distance between the apexes A2 and D2 on the right side of the block BLi in the feed direction; K1′ is the feed direction line being distanced from the apex A2 by Li′/3; and k2′ is the feed direction line distanced from the apex A2 by 2*Li′/3. Note that the W is the pickup width (which is fixed) of the image scanner 10 as described above. And that while the control points B (B1 and B2) and C (C1 and C2) are positioned at a third of the distance between the apexes Li or Li′ of the block BLi here, they are not limited as such.

Then, establishes the intersection between the perpendicular line to the border bi-1 passing the apex A1 and the feed direction line k1 as a control point B1; and the intersection between the perpendicular line to the border bi passing the apex D1 and the feed direction line k2 as another control point C1. Likewise, establishes the intersection between the perpendicular line to the border bi-1 passing the apex A2 and the feed direction line k1′ as a control point B2; and the intersection between the perpendicular line to the border bi passing the apex D2 and the feed direction line k2′ as another control point C2.

Establishing the vector constants A, B, C and D as described above obtains the Bezier curves BZ1 and BZ2 expressed by the above noted equation (4) for approximating the estimation results R1 and R2, thereby smoothing the displacement amounts on the left and right sides, estimating the movements of the left and right ends of the image scanner and determining the external shape of the block BLi.

Subsequently, the reconstruction unit 117, having received the smoothing processing result for the block BLi performed by the smoothing process unit 113, reconstructs the image data within the block BLi by using the mediation variable, t, for the Bezier curves (i.e., displacement amounts) for the left and right sides obtained by the smoothing process unit 113 and based on the inclinations, θi-1 and θi, of the upper and lower borders, bi-1 and bi, thereby eliminating the distortion of the image data within each block BLi. Then, writes the reconstruction result, that is, the corrected image data within the blocks BLi in the corrected image buffer 112 (S139).

In the processing, by establishing the control points B (B1 and B2) and C (C1 and C2) as described for FIG. 37, the reconstruction unit 117 reconstructs the image data within the blocks BLi so that the tangential lines of the image area in the feed direction at the top left and right edges A1 and A2 crosses with the border, bi-1, having the inclinations, θi-1 and θi, on the upper and lower sides, estimated by the inclination estimation unit 119, at the right angle; and the tangential lines of the image area in the feed direction at the bottom left and right edges D1 and D2 crosses with the border bi having the inclination, θi, on the upper and lower sides, estimated by the inclination estimation unit 119, for the blocks BLi as shown by FIG. 38.

Then, judges whether or not the parameter, i, has reached at the number of divisions (i.e., four or five herein) (S140), and, if it has (“yes” in S140), finishes the processing, while, if it has not (“no” in S140), then increments the parameter, i, by one (S141) followed by going back to the step S137. Meanwhile, if the parameter, i, is the one corresponding to the border eliminated by the border elimination unit 122, then neglects the processing of the steps S137 through S139, followed by transitioning to the step S140.

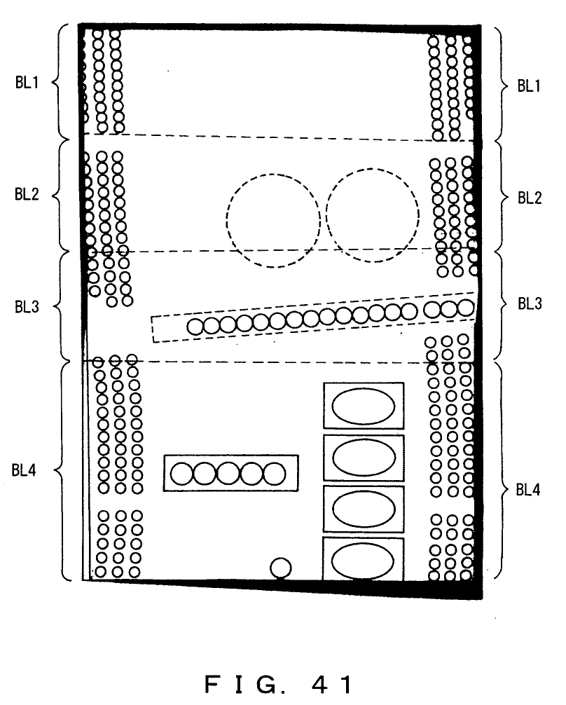

A repetition of the above described processing reconstructs the image data picked up by the image scanner 10 and divided into five blocks as shown by FIG. 39, followed by being integrated into four blocks BL1 through BL4 by the border elimination unit 122 as shown by FIG. 40, now for each of the blocks BLi (i=1 through 4) as shown by FIG. 41.

As such, the image processing apparatus 100C according to the present example is capable of correcting a two-dimensional distortion of image data due to a snaking movement of an image scanner such as a handheld image scanner at the time of picking up the image data for instance, by using the image data, without using a two-dimensional sensor, through the method of dividing the image data into a plurality of blocks BLi and reconstructing the image data within the block BLi for each block BLi, thereby making it possible to obtain a high quality image data, free of distortion, without ushering in a manufacturing cost increase.

In the processing, the inclination of image on the border, bi-1, between the two neighboring blocks BLi-1 and BLi is estimated as the inclination, θi-1, of the border, bi-1, based on the image data straddling the border, bi-1, to adopt the estimated inclination, θi-1, as the result of estimating the inclination of the image on the lower side of the upper block BLi-1 and the inclination of the image on the upper side of the lower block BLi. That is, estimating the inclination, θi-1, of one border bi-1 makes it possible to estimate the inclinations of the lower side of the upper block BLi and of the upper side of the lower block at the same time. Also, the inclination of the lower side of the upper block BLi-1 and that of the upper side of the lower block BLi are estimated as the one common inclination instead of being estimated separately, thereby enabling the reconstructed blocks BLi-1 and BLi to be connected securely with each other in the feed direction without allowing a gap in between.

The use of border elimination unit 122 for judging a border having an angle equal to or greater than a predetermined angle relative to the neighboring border, or a border crossing with another one within an image area, as the one wrongly estimated for the inclination to integrate the two blocks sandwiching the border wrongly estimated for the inclination into one block, making it possible to avoid a reconstruction based on the wrong inclination and reconstruct the image, free of error.

Meanwhile, when estimating the inclination of lower side of an upper block BLi-1 and that of upper side of a lower block BLi are the same inclination, reconstructs image data within respective blocks BLi so that the tangential lines of the image area at the top and bottom, and the left and right edges in the feed direction cross with the inclinations on the top and bottom sides, respectively, for each block BLi. This makes the tangential lines to the left and right edges of the image area in the feed direction lining up smoothly continuously when the reconstructed blocks are joined with each other, making it possible to obtain a high quality image data.

Extracting line data distanced by a suitable interval, d (i.e., 5 to 20 lines), in the feed direction sequentially from each of the left and right sides of the image data area as in the method described in association with FIG. 5, et cetera, to estimate the displacement amounts for the left and right sides, respectively, based on a mutual correlation between the extracted line data in the processing, making it possible to perform an image correction processing efficiently by reducing the computation load for estimating the displacements in the cross feed direction while improving a computation accuracy of the displacement amounts in the cross feed direction.

And the present example, as with the above described other method (part 1), is also capable of suitably correcting a precipitous displacement in the image data caused by a result of moving an image scanner precipitously, thereby acquiring the image data in a higher image quality. A use of Bezier curves (refer to the above noted equation (4)) for a smoothing processing for the aforementioned correction using the mediation variable, t, of the Bezier curves makes a reconstruction of the image data easy.

The present example, as with the above described other method (part 1), is further capable of figuring out easily the inclination of image on the upper and lower sides, θi-1 and θi, of each block BLi based on the inclination of a character string forming a document image as the image data.

The above described image processing apparatuses 100 through 100C are all capable of correcting displacements of image data (i.e., one-dimensional distortion, or two-dimensional distortion due to a snaking) by using the picked up image data only, without using a two-dimensional sensor, and therefore obtaining a high quality image data, free of distortion, without ushering in a manufacturing cost increase.

Note that the above descriptions have taken examples of image data as the processing object being document images, however, any image data containing a rule line, graph, frame line, et cetera, can also be corrected so as to eliminate a distortion of the image in the same way as described above, instead of being limited by the presented examples herein.

In the meantime, the image processing apparatus 100 is actually accomplished by an information processing apparatus such as personal computer. The memories (e.g., RAM, ROM, hard disk) comprised by the information processing apparatus perform the functions of the image buffer 101, first line counter 102, second line counter 103, distance memory 104, minimum mutual correlation coefficient memory 107, displacement counter 108, minimum mutual correlation coefficient position memory 109, displacement memory 110 and corrected image buffer 112. Also, the comprisal is that a CPU comprised by the information processing apparatus executing a prescribed image processing program actually performs the functions of a series of the functional units such as the mutual correlation coefficient computation unit 105, minimum mutual correlation coefficient detection unit 106, linear interpolation process unit 111, et cetera.

As described above, the image combine apparatus 10 according to the present invention is accomplished by a discretionary information processing apparatus (e.g., computer) (and the same goes with the image processing apparatus 100).

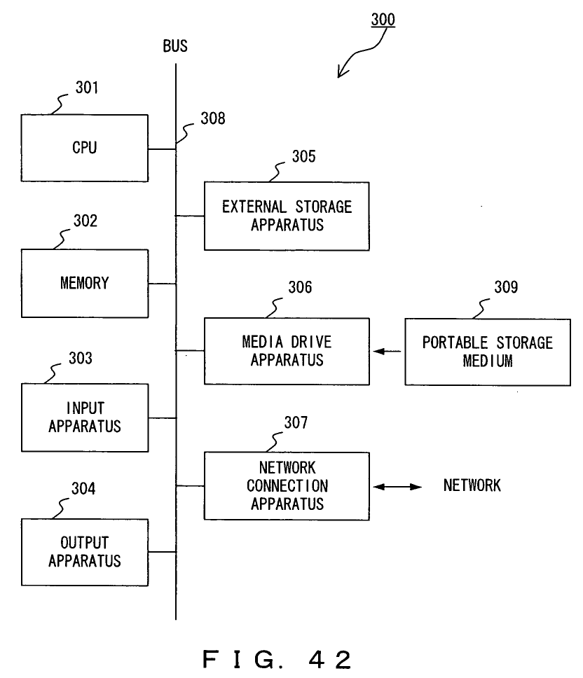

FIG. 42 exemplifies a hardware configuration of such a computer.

The computer 300 shown by FIG. 42 comprises a CPU 301, a memory 302, an input apparatus 303, an output apparatus 304, an external storage apparatus 305, a media driving apparatus 306, a network connection apparatus 307, et cetera, with these components being connected to a bus 308. FIG. 42 only exemplifies a configuration, and not limited as such.

The CPU 301 is the central processing unit for controlling the overall computer 300.

The memory 302 is a memory such as RAM for temporarily storing a program or data stored in the external storage apparatus 305 (or portable storage medium 309 at the time of program execution, data renewal, et cetera). The CPU 301 accomplishes the above described series of processing and functions (i.e., processing shown by FIGS. 2 through 4, etc.; and function of each functional unit shown by FIG. 1, etc.) by executing the program read out to the memory 302.

The input apparatus 303 comprises such as a key board, a mouse, a touch panel, et cetera.

The output apparatus 304 comprises such as a display, a printer, et cetera.

The external storage apparatus 305 comprises such as a magnetic, optical, magneto optical disk apparatuses, for storing the program and/or data for accomplishing the above described series of functions as an image combine apparatus.

The media driving apparatus 306 reads out the program and/or data, et cetera, stored in the portable storage medium 309 which is comprised by, for example, an FD (i.e., flexible disk), CD-ROM, DVD, magneto optical disk, et cetera.

The network connection apparatus 307 is configured for enabling the program and/or data to be transmitted to, and received from, an external information processing apparatus by connecting with a network.

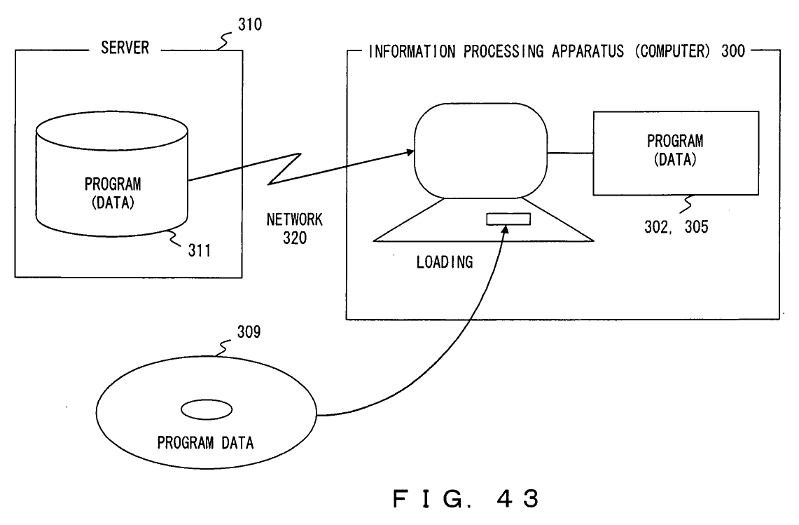

FIG. 43 exemplifies a storage medium storing the above described program and a downloading the aforementioned program.

As shown by FIG. 43, the configuration may be the information processing apparatus 300 reading the program and/or data accomplishing the functions of the present invention out of the portable storage medium 309 and executing it, or the above described program and/or data may be downloaded from a storage unit 311 of the external server 310 by way of a network 320 (e.g., the Internet) through the network connection apparatus 307.

Also the present invention, independent of an apparatus and/or method, may be configured by a storage medium (such as portable storage medium 309) per se, or the above described program per se.

The image combine apparatus, the image combining method, the program, et cetera, according to the present invention is capable of combing a plurality of images in a high precision by first detecting and correcting a distortion of each image singularly so as to detect an overlapping position, and further by detecting and correcting a mutual distortion of the plurality of images, or detecting and correcting an expansion/contraction so as to suppress an influence of pixel displacement in the overlapping position, when combining the plurality of images, even if there is a distortion and/or expansion/contraction in at least one of the plurality of input images being picked up partially in the plurality of times by using a handheld scanner, et cetera.

As such, the present invention has a large contribution to improving an operability and user interface of image input by using a handheld scanner.

1. An image combine apparatus, comprising:
an image distortion detection/correction unit for correcting a distortion of each image based on a result of detecting the distortion of each of a plurality of images being picked up by scanning an object thereof partially in the plurality of times by a manual operation type scanner;
an overlapping position detection unit for detecting a mutual overlapping area of images by using each of the images corrected for distortion;
a mutual image distortion and expansion/contraction detection unit for detecting a mutual distortion of the respective images or an expansion/contraction of image within the detected overlapping area,
an image correction unit for correcting the plurality of images based on the detected mutual distortion of images or the expansion/contraction; and
an image superimpose unit for superimposing the plurality of images after the correction.

2. The image combine apparatus according claim 1, wherein said mutual image distortion and expansion/contraction detection unit detects a mutual distortion of said respective images or an expansion/contraction of image based on a mutual correlation between specific rectangular areas from among each rectangular area made by dividing said overlapping area into a plurality thereof, or between respective character areas within a line image.

3. The image combine apparatus according to claim 2, wherein said specific rectangular area is a rectangular area with a large amount of characteristic.

4. The image combine apparatus according to claims 1, wherein an image used for processing by said image distortion detection/correction unit, overlapping position detection unit or mutual image distortion and expansion/contraction detection unit is a converted image converted from said picked-up plurality of images into an image with a reduced amount of information;
the image distortion detection/correction unit, overlapping position detection unit or mutual image distortion and expansion/contraction detection unit temporarily stores said detection result acquired by using the converted image; and
said image correction unit and image superimpose unit corrects and superimposes, respectively, said plurality of images based on the temporarily stored detection result.

5. The image combine apparatus according to claim 4, wherein said image with a reduced amount of information is a gradation image with a single color component, a binarized image, or a reduced image.

6. The image combine apparatus according to claims 1, wherein said image is a plurality of rows of line data along the cross feed direction being arrayed in the feed direction; and
said image distortion detection/correction unit extracts the line data sequentially distanced by a predetermined interval in the feed direction, estimates displacement amounts in the cross feed direction based on a mutual correlation between the extracted line data and corrects the image so as to eliminate displacement therein based on the estimated displacement amounts.

7. The image combine apparatus according to claim 6, wherein said image distortion detection/correction unit applies a smoothing processing to said estimated displacement amounts in the cross feed direction so that the estimated displacement amounts in the cross feed direction line up on a smooth curve.

8. The image combine apparatus according to claims 6, wherein said image distortion detection/correction unit figures out a displacement amount between each line data existing in between line data distanced by said predetermined interval by applying a linear interpolation based on said displacement amounts in the cross feed direction and corrects said image based on the linear interpolation result.

9. The image combine apparatus according to claims 1, wherein said image is a plurality of rows of line data along the cross feed direction being arrayed in the feed direction;
said image distortion detection/correction unit estimates displacement amounts of the left and right sides of the image, respectively, in the cross feed direction based on a mutual correlation between partial data forming the plurality of line data, detects inclinations of image on the upper and lower sides of the image, respectively, and eliminates a distortion of the image by reconstructing the image based on the estimated displacement amounts in the cross feed direction and the detected inclinations.

10. The image combine apparatus according to claims 1, wherein said image is a plurality of rows of line data along the cross feed direction being arrayed in the feed direction;
said image distortion detection/correction unit divides the image into a plurality of blocks in the feed direction, estimates inclinations of image on the upper and lower parts of the each block, estimates displacement amounts of the left and right sides of the each block in the cross feed direction based on a mutual correlation between partial data forming line data within each block and eliminates a distortion of image within the block by reconstructing image data within the block for the each block, based on the estimated displacement amounts in the cross feed direction and the estimated inclinations of the upper and lower parts.

11. An image combining method, comprising the steps of
correcting a distortion of each image based on a result of detecting the distortion of each of a plurality of images being picked up by scanning an object thereof partially in the plurality of times by a manual operation type scanner;
detecting a mutual overlapping area of images by using each of the image corrected for distortion; detecting a mutual distortion of the respective images or an expansion/contraction of image within the detected overlapping area;
correcting the plurality of images based on the detected mutual distortion of images or the expansion/contraction; and
superimposing the plurality of images after the correction.

12. A program for making a computer accomplish the functions of
correcting a distortion of each image based on a result of detecting the distortion of each of a plurality of images being picked up by scanning an object thereof partially in the plurality of times by a manual operation type scanner;
detecting a mutual overlapping area of images by using each of the images corrected for distortion;
detecting a mutual distortion of the respective images or an expansion/contraction of image within the detected overlapping area,
correcting the plurality of images based on the detected mutual distortion of images or the expansion/contraction; and
superimposing the plurality of images after the correction.

13. A computer readable storage media storing a program for making a computer accomplish the functions of
correcting a distortion of each image based on a result of detecting the distortion of each of a plurality of images being picked up by scanning an object thereof partially in the plurality of times by a manual operation type scanner;
detecting a mutual overlapping area of images by using each of the image corrected for distortion;
detecting a mutual distortion of the respective images or an expansion/contraction of image within the detected overlapping area;
correcting the plurality of images based on the detected mutual distortion of images or the expansion/contraction; and
superimposing the plurality of images after the correction.
